(19) United States
(12) Patent Application Publication
(10) Pub. No.: US 2020/0133532 A1
(43) Pub. Date: Apr. 30, 2020

(54) Geological Allocation of Storage Space

(71) Applicant: EMC IP Holding Company LLC, Hopkinton, MA (US)

(72) Inventors: Mikhail Danilov, Saint Petersburg (RU); Konstantin Buinov, Prague (CZ)

(21) Appl. No.: 16/177,278

(22) Filed: Oct. 31, 2018

(51) Int. Cl. G06F 3/06; H04L 12/26

(52) U.S. Cl. CPC G06F 3/0631; G06F 3/065; H04L 43/0882; G06F 3/067; G06F 3/0607; G06F 3/0626

(57) ABSTRACT

Geological allocation of storage space for a zone of a geographically diverse storage system is disclosed. A first allocation of storage space of the first zone can be adapted. In some embodiments, the adaptation can result in changes to a size of a storage area for a type of data stored in the first zone. In some embodiments, the adaptation can result in changes to a location of a storage area for a type of data stored in the first zone. In an aspect, the adaptation can result in improved inter-zone network utilization. In another aspect, the adaptation can result in efficient use of storage space in view of the amount and type of data to be stored in the zone. In an embodiment, the types of data stored can comprise a buffer space, local data, remote data, and combined or convolved data.

### TECHNICAL FIELD

The disclosed subject matter relates to data convolution, more particularly, to allocation of storage space for a storage zone of geographically diverse storage zones.

### BACKGROUND

Conventional data storage techniques can employ convolution and deconvolution of data to conserve storage space. As an example, convolution can allow data to be packed or hashed in a manner that uses less space that the original data. Moreover, convolved data, e.g., a convolution of first data and second data, etc., can typically be de-convolved to the original first data and second data. One use of data storage is in bulk data storage.

### BRIEF DESCRIPTION OF DRAWINGS

FIG. 1 is an illustration of an example system that can facilitate allocation of storage space for a storage zone of geographically diverse storage zones of a geographically diverse storage construct, in accordance with aspects of the subject disclosure.

FIG. 2 is an illustration of example system states for allocation of storage space for a storage zone of geographically diverse storage zones, in accordance with aspects of the subject disclosure.

FIG. 3 is an illustration of an example system that can enable adapting an allocation of storage space for a storage zone of geographically diverse storage zones, in accordance with aspects of the subject disclosure.

FIG. 4 illustrates an example system that can facilitate rule based allocation of storage space for a storage zone of geographically diverse storage zones, in accordance with aspects of the subject disclosure.

FIG. 5 is an illustration of an example system that can facilitate allocation of storage space for a storage zone of geographically diverse storage zones, in accordance with aspects of the subject disclosure.

FIG. 6 is an illustration of an example method facilitating allocation of storage space for a storage zone of geographically diverse storage zones of a geographically diverse storage construct, in accordance with aspects of the subject disclosure.

FIG. 7 is an illustration of an example method facilitating network traffic sensitive allocation of storage space for a storage zone of geographically diverse storage zones, in accordance with aspects of the subject disclosure.

FIG. 8 illustrates an example method that enables data pressure sensitive allocation of storage space for a storage zone of geographically diverse storage zones, in accordance with aspects of the subject disclosure.

FIG. 9 depicts an example schematic block diagram of a computing environment with which the disclosed subject matter can interact.

FIG. 10 illustrates an example block diagram of a computing system operable to execute the disclosed systems and methods in accordance with an embodiment.

### DETAILED DESCRIPTION

The subject disclosure is now described with reference to the drawings, wherein like reference numerals are used to refer to like elements throughout. In the following description, for purposes of explanation, numerous specific details are set forth in order to provide a thorough understanding of the subject disclosure. It may be evident, however, that the subject disclosure may be practiced without these specific details. In other instances, well-known structures and devices are shown in block diagram form in order to facilitate describing the subject disclosure.

As mentioned, data storage techniques can employ convolution and deconvolution to conserve storage space. As an example, convolution can allow data to be packed or hashed in a manner that uses less space that the original data. Moreover, convolved data, e.g., a convolution of first data and second data, etc., can typically be de-convolved to the original first data and second data. One use of data storage is in bulk data storage. Examples of bulk data storage can include networked storage, e.g., cloud storage, for example Elastic Cloud Storage offered by Dell EMC. Bulk storage can, in an aspect, manage disk capacity via partitioning of disk space into blocks of fixed size, frequently referred to as chunks, for example a 128 MB chunk, etc. Chunks can be used to store user data, and the chunks can be shared among the same or different users, for example, one chunk may contain fragments of objects from several users. A chunk's content can generally be modified in an append-only mode to prevent overwriting of data already added to the chunk. As such, when a typical chunk becomes full enough, it can be sealed so that the data therein is generally not able for further modification. These chunks can be then stored in a geographically diverse manner to allow for recovery of the data, such as if a first copy of the data is destroyed, e.g., disaster recovery, etc. Blocks of data, hereinafter ‘data chunks’, or simply ‘chunks’, can be used to store user data. Chunks from a data storage device, e.g., ‘zone storage component’ (ZSC), ‘zone storage device’ (ZSD), etc., located in a first geographic location, hereinafter a ‘zone’, etc., can be stored in a second zone storage device that is located at a second geographic location different from the first geographic location. This can enable recovery of data where the first zone storage device is damaged, destroyed, offline, etc., e.g., disaster recovery of data, by accessing the off-site data from the second zone storage device.

Geographically diverse data storage can use data compression to store data. As an example, a storage device in Topeka can store a backup of data from a first zone storage device in Houston, e.g., Topeka can be considered geographically diverse from Houston. As a second example, data chunks from Seattle and San Jose can be stored in Denver. The example Denver storage can be compressed or uncompressed, wherein uncompressed indicates that the Seattle and San Jose chunks are replicated in Denver, and wherein compressed indicates that the Seattle and San Jose chunks are convolved, for example via an exclusive-or operation, hereinafter ‘XOR’, into a different chunk to allow recovery of the Seattle or San Jose data from the convolved chunk, but where the convolved chunk typically consumes less storage space than the sum of the storage space for both the Seattle and San Jose chunks individually. In an aspect, compression can comprise convolving data and decompression can comprise deconvolving data, hereinafter the terms compress, compression, convolve, convolving, etc., can be employed interchangeably unless explicitly or implicitly contraindicated, and similarly, decompress, decompression, deconvolve, deconvolving, etc., can be used interchangeably. Compression, therefore, can allow original data to be recovered from a compressed chunk that consumes less storage space than storage of corresponding uncompressed data chunks. This can be beneficial in that data from a location can be backed up by redundant data in another location via a compressed chunk, wherein a redundant data chunk can be smaller than the sum of the data chunks contributing to the compressed chunk. As such, can be compressed via a convolution technique to reduce the amount of storage space used at a geographically distinct location.

A convolved chunk stored at a geographically diverse storage device, e.g., ZSC, ZSD, in a zone, etc., can comprise data from some or all storage devices of a geographically diverse storage system. As an example, where there are five storage devices corresponding to different storage zones of the geographically diverse storage system, a first zone can comprise unconvolved or convolved chunks from the other four storage devices to create a ‘backup’ of the data from the other four storage devices, albeit the convolved chunks can consume less storage space than the unconvolved chunks. In this example, the first storage device can, in an embodiment, create a backup chunk from chunks received from the other four storage devices. In an aspect, this can result in generating copies of the four received chunks at the first storage device and, in some embodiments, then convolving the four chunks to generate a fifth chunk that is a backup of the other four chunks. Moreover, one or more other copies of the four chunks and/or the fifth chunk can be created at the first storage device for redundancy. In another example, the first storage device can convolve chunks from three of the other four storage devices, etc.

In an embodiment of the disclosed subject matter, a first data chunk and a second data chunk corresponding to a first and second zone that are geographically diverse can be stored in a third data chunk stored at third zone that is geographically diverse from the first and second zones. In an aspect the third chunk can represent the data of the first and second data chunks in a compressed form, e.g., the data of the first data chunk and the second data chunk can be convolved, such as by an XOR function, into the third data chunk. In some embodiments, convolved chunks can be further convolved with other chunks and/or other convolved chunks to yield a further convolved chunk, e.g., chunk A can be convolved with chunk B to yield chunk AB, which can be convolved with chunk C to yield chunk ABC, which can be convolved with chunk DEF to yield chunk ABCDEF, etc. In an embodiment, first data of the first data chunk and second data of the second data chunk can be convolved with or without replicating the entire first data chunk and the entire second data chunk at data store(s) of the third zone, e.g., as at least a portion of the first data chunk and at least a portion of the second data chunk are received at the third zone, they can be convolved to form at least a portion of the third data chunk. In an aspect, where compression occurs without replicating a chunk at another zone prior to compression, this can be termed as ‘on-arrival data compression’ and can reduce the count of replicate data made at the third zone and data transfers events can correspondingly also be reduced. In an aspect, a ZSC can comprise one or more data storage components that can be communicatively coupled, e.g., a ZSC can comprise one data store, two or more communicatively coupled data stores, etc. In an aspect, this can allow replication of data in the ZSC and can provide data redundancy in the ZSC, for example, providing protection against loss of one or more data stores of a ZSC. As an example, a ZSC can comprise multiple hard drives and a chunk can be stored on more than one hard drive such that, if a hard drive fails, other hard drives of the ZSC can comprise the chunk, or a replicate of the chunk.

In an aspect, as data in chunks becomes stale, old, redundant, etc., it can be desirable to delete these chunks to free storage space for other uses. In an aspect, a convolved chunk can be de-convolved, partially or completely, to yield other chunks, e.g., the other chunks can represent the same data as the convolved chunk but the other chunks can typically consume more storage space that the convolved chunk because these other chunks are ‘less highly convolved’. As an example, the chunk (AB(CD)), which can be chunk A convolved with Chunk B convolved with a chunk that itself is a convolution of chunks C and D, can be deconvolved into chunks A to D, into chunks A, B, and (CD), into chunks A and B(CD), etc. Moreover, in this example, because the convolution can be commutative, such as where an XOR function is used to convolve/deconvolve the data, the chunk (AB(CD)) can be deconvolved into, for example, chunks B and A(CD), chunks A, D, and (BC), etc. Where a chunk is to be deleted in a remote zone, the deconvolution can comprise transfer of other chunks to facilitate the deconvolution. As an example, where the chunk (AB(CD)) is at a first zone, and chunk D is to be deleted, data for one or more of chunks A, B, and C, can be replicated in the first zone from other zones to facilitate deconvolution, e.g., (AB(CD) XOR (ABC), where data for one or more of chunks A, B, and C, is replicated into the first zone, and can result in chunks (ABC) and D, such that chunk D can be deleted and leave just chunk (ABC) at the first zone. As such, it can be desirable to reduce the resource consumption in replicating chunks between zones to facilitate the deletion of a chunk from a convolved chunk. As an example, it can consume less bandwidth to replicate chunk (ABC) from a second zone to the example first zone as compared to replicating each of chunk A, chunk B, and chunk C from the second zone to the first zone. This can be accommodated, for example, by first, in the second zone, generating a compressed chunk (ABC), such as from chunks A, B, and C, from chunk AB and chunk C, from chunk AC and chunk B, etc., prior to replicating generated chunk ABC into the first zone.

In an aspect, compression/convolution of chunks can be performed by different compression/convolution technologies. Logical operations can be applied to chunk data to allow compressed data to be recoverable, e.g., by reversing the logical operations to revert to an earlier form of chunk data. As an example, data from chunk 1 can undergo an exclusive-or operation, hereinafter ‘XOR’, with data from chunk 2 to form chunk 3. This example can be reversed by XORing chunk 3 with chunk 2 to generate chunk 1, etc. While other logical and/or mathematical operations can be employed in compression of chunks, those particular operation details are generally beyond the scope of the presently disclosed subject matter and, for clarity and brevity, only the XOR operator will be illustrated herein, however, it is noted that the disclosure is not so limited to just XOR operations and that those other operations or combinations of operations can be substituted without departing from the scope of the present disclosure. As such, all logical and/or mathematical operations for compression germane to the disclosed subject matter are to be considered within the scope of the present disclosure even where not explicitly recited for the sake of clarity and brevity.

In an aspect, the presently disclosed subject matter can, as mentioned, include ‘zones’. A zone can correspond to a geographic location or region. As such, different zones, e.g., where a zone can connote a group of ZSCs or ZSDs in a geographic area, etc., can be associated with different geographic locations or regions. As an example, Zone A can comprise Seattle, Wash., Zone B can comprise Dallas, Tex., and, Zone C can comprise Boston, Mass. In this example, where a local chunk from Zone A is replicated, e.g., compressed or uncompressed, in Zone C, an earthquake in Seattle can be less likely to damage the replicated data in Boston. Moreover, a local chunk from Dallas can be convolved with the local Seattle chunk, which can result in a compressed/convolved chunk, e.g., a partial or complete chunk, which can be stored in Boston. As such, either the local chunk from Seattle or Dallas can be used to de-convolve the partial/complete chunk stored in Boston to recover the full set of both the Seattle and Dallas local data chunks. The convolved Boston chunk can consume less disk space than the sum of the separate Seattle and Dallas local chunks. An example technique can be “exclusive or” convolution, hereinafter ‘XOR’, ‘⊕’, etc., where the data in the Seattle and Dallas local chunks can be convolved by XOR processes to form the Boston chunk, e.g., C=A1⊕B1, where A1 is a replica of the Seattle local chunk, B1 is a replica of the Dallas local chunk, and C is the convolution of A1 and B1. Of further note, the disclosed subject matter can be employed in more or fewer zones, in zones that are the same or different than other zones, in zones that are more or less geographically diverse, etc. As an example, the disclosed subject matter can be applied to data of a single disk, a memory, a drive, a data storage device, etc., without departing from the scope of the disclosure, e.g., the zones can represent different logical areas of the single disk, memory, drive, data storage device, etc. Moreover, it will be noted that convolved chunks can be further convolved with other data, e.g., D=C1⊕E1, etc., where E1 is a replica of, for example, a Miami local chunk, E, C1 is a replica of the Boston partial chunk, C, e.g., a convolved chunk, from the previous example, such that D is an XOR of C1 and E1 and can be, for example, located in Fargo.

In an aspect, XORs of data chunks in disparate geographic locations can provide for de-convolution of the XOR data chunk to regenerate the input data chunk data. Continuing a previous example, the Fargo chunk, D, can be de-convolved into C1 and E1 based on either C1 or D1; the Miami chunk, C, can be de-convolved into A1 or B1 based on either A1 or B1; etc. Where convolving data into C or D comprises deletion of the replicas that were convolved, e.g., A1 and B1, or C1 and E1, respectively, to avoid storing both the input replicas and the convolved chunk, de-convolution can rely on retransmitting a replica chunk that so that it can be employed in de-convoluting the convolved chunk. As an example the Seattle chunk and Dallas chunk can be replicated in the Boston zone, e.g., as A1 and B1. The replicas, A1 and B1 can then be convolved into C. Replicas A1 and B1 can then be deleted because their information is redundantly embodied in C, albeit convolved, e.g., via an XOR process, etc. This leaves only chunk C at Boston as the backup to Seattle and Dallas. If either Seattle or Dallas is to be recovered, the corollary input data chunk can be used to de-convolve C. As an example, where the Seattle chunk, A, is corrupted, the data can be recovered from C by de-convolving C with a replica of the Dallas chunk B. As such, B can be replicated by copying B from Dallas to Boston as B1, then de-convolving C with B1 to recover A1, which can then be copied back to Seattle to replace corrupted chunk A.

In some circumstances, disk space management can seek to recover underutilized disk space. As an example, where the Seattle chunk, A, is to be deleted, recovery of the Dallas chunk, B, via Boston convolved chunk, C, becomes dependent on having a copy of B to de-convolve C with after A has been deleted. As such, it can be desirable to de-convolve C into A1 and B1 prior to deleting A and A1, such that B1 can be convolved with another chunk, for example Miami chunk, E. As such, recovery of B1 can be based on E1 and the XOR of B1E1. Also of note, to de-convolve C in to A1 and B1, a replica of A, e.g., A1 is made in Boston, this allows recovery of B1. Once B1 is recovered, C, A1, and A can be deleted. Then B1 can be convolved with E1. It will be noted that data is transferred, e.g., A is copied into A1 from Seattle to Boston, to allow C to be de-convolved.

The use of storage space in a zone, e.g., across one or more storage modalities, storage devices, etc., can be regulated, adapted, etc. This can provide adequate space for the storage of local data, local chunks, etc., e.g., data from a device proximate to a Seattle zone can be selected for storage in the Seattle zone, etc., by balancing the local storage of data against storage of data from other zones, e.g., data from a device proximate to a Boston zone selected for storage in the example Seattle zone. In an embodiment, zone can comprise unused storage space that can be allocated to, for example, a storage zone buffer, unused storage zone space, local data storage, remote data storage, cached remote data (CRD) storage, combined or convolved data storage, etc. In an aspect, the storage space of a zone can, at an initial point, be entirely unused storage space, e.g., when a zone is initially formed there can be no data yet stored in the zone, excluding space on storage devices/modalities that are typically not otherwise available for storage, such as, file tables, reserved space, operating instructions, etc. As an example, a 1 TB hard drive can generally have less than the full 1 TB available for user storage, etc. Ignoring this generally inaccessible zone overhead, the balance of the ‘available storage space,’ initially typically unused storage space, can be allocated for use. In an aspect, a portion of the unused space can be employed as a buffer. The buffer can facilitate read operations into the zone storage space, write operations into the zone storage space, etc., and will be appreciated to be preferable to operation of storage space without a designated buffer.

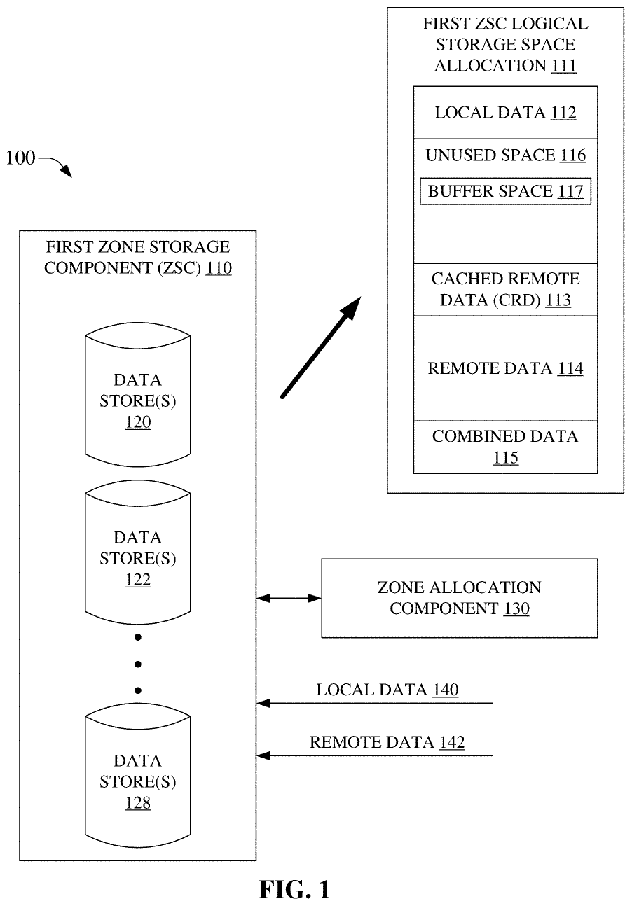

Other than reservation of a buffer from the unused space, the balance of the unused space can be employed for other types of data storage. In an aspect, data generated local tot the zone, e.g., by devices associated with, or proximate to, the zone can be stored at the zone as ‘local data’. Correspondingly, other data can be termed ‘remote data,’ or variations thereof, e.g., cached remote data that can be remote data stored in a manner to improve access in comparison to other remote data, for example by storing cached remote data in a manner that improved access speed to the stored cached remote data in comparison to another manner of storing remote data, e.g., remote data can be stored on a 5400 rpm hard drive of the zone while cached remote data can be stored at a 7200 rpm or 10,000 rpm hard drive of the zone, remote data can be stored on a hard drive of the zone while cached remote data can be stored in solid state drive (SSD), remote data can be stored on a 5400 rpm hard drive of the zone and be connected via a 100 mbps network while cached remote data can be stored in 5400 rpm hard drive connected via a 1000 mbps network, etc. Accordingly, cached remote data can typically be associated with faster access in contrast to remote data. In some embodiments, the faster access to cached remote data can be associated with different costs of storage per unit of storage, e.g., a 1000 mbps network connection can be more costly than a 100 mbps connection, a 10,000 rpm hard drive can be more costly than a 5400 rpm hard drive, SSD modalities can be more costly than tape drives, etc. Of note, the higher costs can be monetary costs, operational costs, maintenance costs, mean time between failure costs, environmental costs (heating, cooling, energy use, etc., of storage devices), space costs (a rack of SSDs can consume less space in a data center than a corresponding bank of hard drives, tape drives, etc.), or nearly any other cost associated with operation of storage devices comprising a zone. In a further aspect, the unused space can be allocated to storage of combined data, e.g., convolved data, etc. The allocation of zone space can be termed ‘logical storage space allocation,’ for example as illustrated in FIG. 1, at first ZSC logical storage space allocation 111, ‘space allocation,’ logical allocation,′ ‘allocation,’ or other similar terms.

In an embodiment, a first allocation can be adapted, resulting in a second allocation. The adaptation can be based on various indications, such as, but not limited to, an amount of unused space, a change in an overall storage capacity of a zone, planned changes to a storage zone, unplanned changes to a zone, moving data from or into another zone, inter-zone traffic or operations, intra-zone traffic or operations, a significance of data, etc. In an aspect, the change in an overall storage capacity of a zone can result from adding, removing, failure, inaccessibility to, etc., a portion of the storage space, for example resulting from adding more storage capacity to the zone, failure of a storage device of the zone, network conditions that alter accessibility to a portion of the storage space of a zone, etc. In an aspect, the significance of data can be related to an importance of data, importance of access to data, etc., and can be comparable to a significance of other data, e.g., ranking data by importance, ranking by an importance of access to the data, etc. The ranking, can also be termed a ‘data temperature’, e.g., cold data can be of lower importance, or access thereto can be of lower importance, than data/access to ‘warmer’ data, with ‘hot data’ able to be considered even more important or of higher rank, weight, etc.

The ranking can also be associated with a ‘data pressure,’ termed as such to connote that the importance rank, access rank, etc., can be associated with allocation of room for that data differently than allocation of room for other data having a different ranking, e.g., newly received ‘hot data’ can be stored in cached remote data space, which can push other differently ranked data out of the cached remote data space or cause the cached remote data space to be altered. In this example, where there is unused space in the zone, the cached remote data space can be expanded where it is undesirable to push the other differently ranked data out of the cached remote data space. Further in this example, even where there is unused space in the zone, where it is undesirable to expand the cached remote data space, the other data can be push out of the cached remote data space, for example into space allocated for remote data, into compressed data space via convolution with other data, etc. The choice to expand the cached data space or to push the other differently ranked data to a differently allocated space can, for example, depend on the unit cost of storage, as discussed elsewhere herein, for cached or other types of storage allocations, on traffic costs associated with moving the other data to free up cached remote data space, processor time associated with reallocation of the other data, or nearly any other factor. Similarly, combining the example other differently ranked data can be associated with processor time/cycles, energy costs, storage space allocation considerations, etc., that can impact any determination on how to preferably accommodate the example newly received hot data. In an aspect, one or more rules can be employed in determining allocation, reallocation, etc., of storage space based on one or more criterion. As an example, a customer of an entity operating a zone can pay a higher fee for storage/access to some portion of their data, which can be associated with a ‘weighting’ of a portion of that customer's data that affects the allocation of zone storage space to comport with the customer paying the higher fee, e.g., a customer can pay to improve the ranking of a portion of their data such that the improved ranking of their data can be considered in allocation, reallocation, etc., of storage space for a corresponding zone.

Ranking of data can similarly be related to historical information, e.g., data for storage at a first zone that is received from a second zone can be ranked differently based on historical information about data from the second zone, e.g., where the second zone historically is more prone to hurricane events and thus can have more frequent requests for data from the first zone to accommodate data recovery after a data loss form a hurricane, this historical information can be employed to change the ranking of data from the second zone proximate to hurricane season, for example keeping data from the second zone more frequently out of combined data storage space because access to data in the combined data storage space can be associated with additional processing overhead, cost, energy overhead, etc., to deconvolve a combined chunk to access the requested recovery data, while in contrast, storing the chunk in a remote data space may require less processing, cost, energy, etc., to access the recovery data but may not be associated with different costs associated with storing the recovery data in provisioned cached remote data space.

Allocation of storage space can, in some embodiments, be related to traffic metrics, e.g., an inter-network traffic metric, an intra-network traffic metric, etc., or other zone metrics, such as, processing time/cycles, random access memory usage, environmental conditions, cost of power, etc. As an example, where a zone has a first logical storage space allocation, a change in operating costs/conditions, such as increased air conditioning during a stretch of hot weather, increased electrical pricing via municipality, planned repairs to devices of the corresponding ZSC, etc., can lead to reallocation of the storage space. The reallocation can, for example, seek to shift storage to less energy consuming allocations balanced against speed of data access, shift storage to cooler storage modalities, allocate space in a manned resulting in data storage devices of the zone scheduled for maintenance to have unused space only (e.g., moving data off of a hard drive to allow the hard drive to be replaced as part of planned maintenance, etc.), alter space allocated to different data temperatures to affect a customer experience, change a buffer space allocation to comport with updated best practices, etc.

It will be readily appreciated that the ‘stack’ of allocation types represented in a logical storage space allocation, can resemble geological strata. In an aspect, the term ‘geological allocation of storage space’ can connote that the different ‘layers,’ e.g., data storage space types, etc., can exert pressure on other layers and, in some embodiments, can be associated with rules resulting in allocation of storage space. In an example, as local data space grows, it can be viewed as putting pressure on cached remote data space and remote data space. To accommodate this example data pressure, data, e.g., data chunks, etc., can be combined, convolved, etc., to consume less storage space and thereby increase use of combined data space while reducing use of cached remote and/or remote data space. It will be appreciated that where there remains unused space in the zone, compression of data into the example convolved data chunk can be avoided in some cases where it is preferable to grow a cached remote or remote data space allocation instead, etc. In an aspect, generally as a zone ages, there can be increased local data and remote data that can cause pressure resulting in movement of data into a combined storage space of the zone. In some instances, this exemplary aging can result in the zone comprising only a buffer, local data, and combined data with no room allocated to cached remote data or remote data. In an embodiment of these instances, addition of more storage devices to the zone can rejuvenate the zone by increasing unused space that can then be employed in allocation of the zone storage space. In another embodiment of these instances, additional convolution of data can free space that can be used in reallocation of the zone storage space. In some embodiments of these instances, deconvolution and deletion of data from combined data can free space, or by corollary, moving data to other zones can also free space for reallocation.

To the accomplishment of the foregoing and related ends, the disclosed subject matter, then, comprises one or more of the features hereinafter more fully described. The following description and the annexed drawings set forth in detail certain illustrative aspects of the subject matter. However, these aspects are indicative of but a few of the various ways in which the principles of the subject matter can be employed. Other aspects, advantages, and novel features of the disclosed subject matter will become apparent from the following detailed description when considered in conjunction with the provided drawings.

FIG. 1 is an illustration of a system 100, which can facilitate allocation of storage space for a storage zone of geographically diverse storage zones of a geographically diverse storage construct, in accordance with aspects of the subject disclosure. System 100 can comprise first zone storage component (ZSC) 110 that can receive locate data 140, remote data 142, etc., for storage in a first zone comprising first ZSC 110. In an aspect first ZSC 110 can be one or several ZSCs comprised in a zone storage construct, e.g., a zone storage system can comprise first ZSC 110, a second ZSC, a third ZSC, etc., correspondingly representing a first zone a second zone, a third zone, etc. The ZSCs can typically communicate with the other ZSCs of a zone storage system. A zone can correspond to a geographic location or region. As such, different zones can be associated with different geographic locations or regions. A ZSC can comprise one or more data stores in one or more locations corresponding to the zone, e.g., data store(s) 120-128, etc. In an aspect, a ZSC can store at least part of a data chunk on at least part of one data storage device, e.g., hard drive, flash memory, optical disk, server storage, etc., of the at least one data store(s) 120-128. Moreover, a ZSC can store at least part of one or more data chunks on one or more data storage devices, e.g., on one or more hard disks, across one or more hard disks, etc. As an example, a ZSC can comprise one or more data storage devices in one or more data storage centers corresponding to a zone, such as a first hard drive in a first location proximate to Miami, a second hard drive also proximate to Miami, a third hard drive proximate to Orlando, etc., where the related portions of the first, second, and third hard drives correspond to, for example, a ‘Florida zone’, ‘Southeastern United States zone’, etc.

In an aspect, data chunks can be replicated in their source zone, in a geographically diverse zone, in their source zone and one or more geographically diverse zones, etc. As an example, a Seattle zone can comprise a first chunk that can be replicated in the Seattle zone to provide data redundancy in the Seattle zone, e.g., the first chunk can have one or more replicated chunks in the Seattle zone, such as on a different storage device(s), e.g., data store(s) 120-128, etc., corresponding to the Seattle zone, thereby providing data redundancy that can protect the data of the first chunk, for example, where a storage device storing the first chunk or a replicate thereof becomes compromised, the other replicates (or the first chunk itself) can remain uncompromised. In an aspect, data replication in a zone can be on one or more storage devices, e.g., data store(s) 120-128, etc., for example, a chunk can be stored on a first data storage device, e.g., data store(s) 120, a second chunk can be stored on a second storage device, e.g., data store(s) 122, and a third chunk can be stored on a third storage device, e.g., data store(s) 128, wherein the first, second, and third storage devices, e.g., data store(s) 120-128, etc., correspond to the first zone, and wherein the first, second, and third storage devices can be the same storage device or different storage devices. Replication of chunks, e.g., the first chunk, into other chunks can comprise communicating data, e.g., over a network, bus, etc., to other data storage locations on the first, second, and third storage devices and, moreover, can consume data storage resources, e.g., drive space, etc., upon replication. As such, the number of replicates can be based on balancing resource costs, e.g., network traffic, processing time, cost of storage space, etc., against a level of data redundancy, e.g., how much redundancy is needed to provide a level of confidence that the data/replicated data will be available within a zone. In an aspect, replication of chunks can enable deconvolution of convolved chunks at another zone(s). Deconvolution of a convolved chunk can facilitate deletion of data from a convolved chunk.

A geographically diverse storage system, e.g., a system comprising system 100, can replicate chunks from first ZSC 110, etc., at another ZSC, and replicate data of other zones as chunks in first ZSC 110, etc. A chunk can be replicated with or without convolution and, moreover, can be replicated relative to their data temperature, etc., e.g., into cached remote data space 113, into remote data space 114, into a combined data space 115, etc. A chunk can be a convolved chunk comprising data representative of other chunks, e.g., a first chunk can be a convolved chunk comprising data representative of a second chunk, a third chunk, etc. Accordingly, the first chunk can be deconvolved, e.g., by XOR with the second chunk, etc., to yield the third chunk, etc.

System 100 can comprise zone allocation component (ZAC) 130. ZAC 130 can be communicatively coupled to first ZSC 110. ZAC 130 can initiate a change to the storage of data at first ZSC 110, e.g., first ZSC logical storage space allocation 111 can be adapted from a first allocation to a second allocation of storage space comprising one or more of local data space 112, unused space 116, buffer space 117, CRD space 113, remote data space 114, combined data space 115, etc. ZAC 130 can initiate the change based on a first storage state, e.g., a first allocation of storage space for first ZSC logical storage space allocation 111, etc., resulting in a second storage state for the first ZSC 110 of a first zone. As an example, a new data store(s) can be added to first ZSC 110, thereby increasing unused space 116, which can be indicated to ZAC 130 such that ZAC 130 can determine adaptation information used to initiate a corresponding change to first ZSC logical storage space allocation 110 that can, for example, use a portion of the newly added unused space 116 to increase remote data space 113, increase combined data space 115, etc. This adaptation can comprise other adaptations, such as increasing local data space 112, etc. As another example, network congestion can relate to a decrease in accessibility of remote data space 114 as allocated across one or more of data store(s) 120-128, etc., which can be indicated to ZAC 130, which can correspondingly, for example, increase remote data space 114 to comprise space on one or more of data store(s) 120-128, etc., that are less affected, or not affected, by the network congestion to enable storage of incoming remote data 142 efficiently in the newly allocated remote data space 114, e.g., instructing allocation of additional less affected remote data space can enable first ZSC 110 to place newly arriving remote data 142 in the newly allocated portion of remote data space 114 subject to less effect from the network congestion that can be afflicting another portion of remote data space 114.

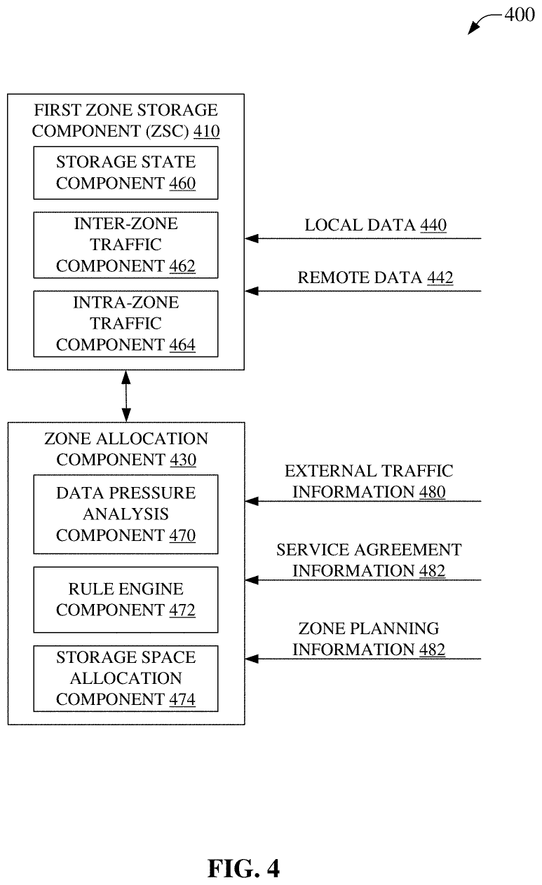

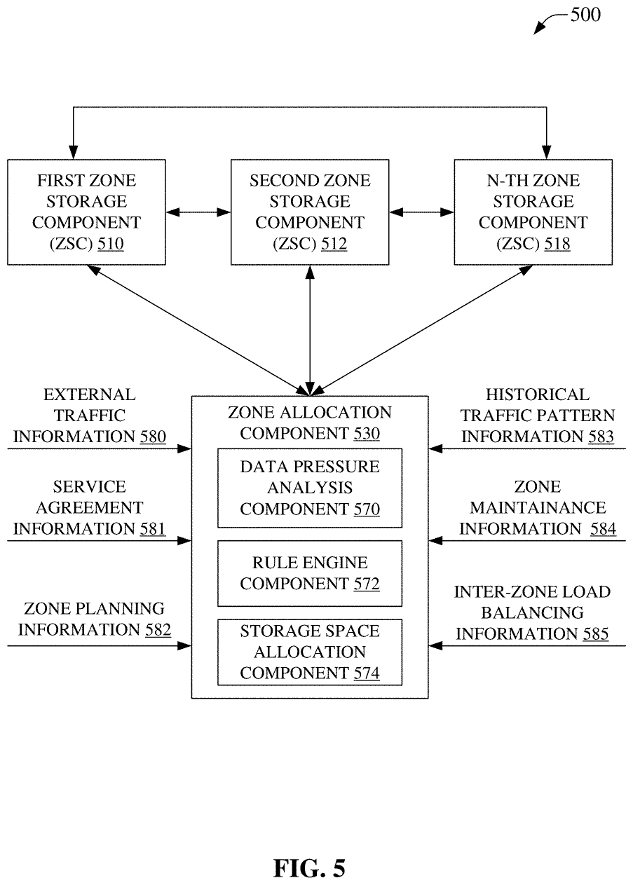

ZAC 130 can determine adaptation information for storage of data under a reallocation of first ZSC logical storage space allocation 111 based on other indications. In an aspect these other indications can be received from first ZSC 110. In some embodiments, these other indications can be received from other components, for example, as illustrated in FIG. 4, e.g., current traffic information 480, service agreement information 482, zone planning information 482, etc., FIG. 5, e.g., historical traffic patter information 583, zone maintenance information 584, inter-zone load balancing information 585, etc., can be received from other devices, such as, from a customer server, from a zone storage construct provider device, via second ZSC 512, N-th ZSC 518, etc.

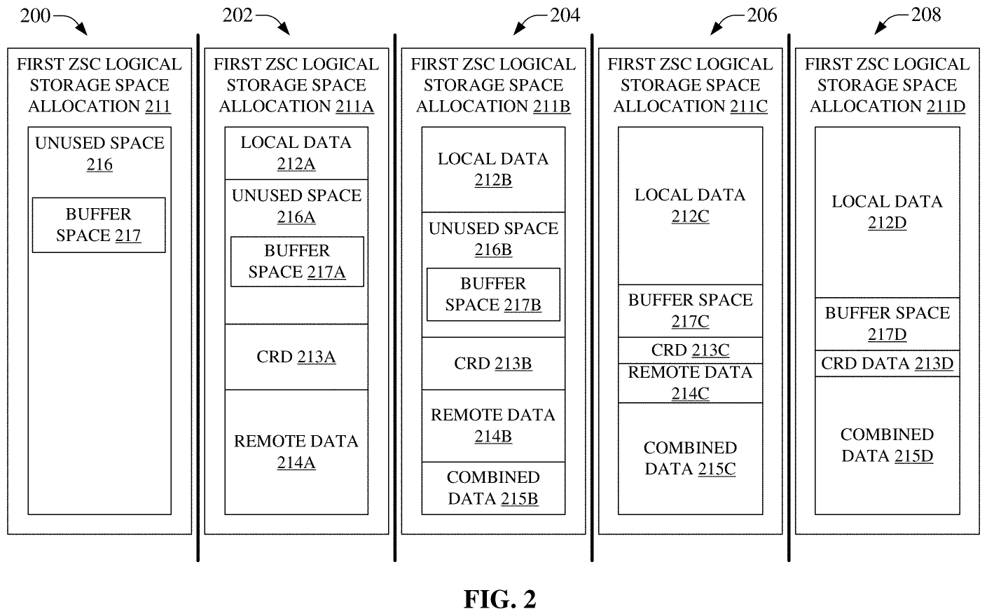

It can be observed, in FIG. 1, etc., that first ZSC logical storage space allocation 111 can comprise allocated space that can resemble geological strata. The different ‘layers,’ e.g., data storage space types, etc., can exert pressure on other layers and, in some embodiments, can be associated with rules resulting in allocation of storage space. Data pressure from the different layers of data can be indicated to ZAC 130, which can determine an adaptation of the allocation and initiate a corresponding change to the allocation, resulting in a second ZSC location storage space allocation (not illustrated in FIG. 1, see FIG. 2, etc.). As an example, increased loading of local data space 112 can compress unused space 116 until only buffer space 117 remains. This information can be indicated to ZAC 130, which can determine an adaptation and initiate a change that, for example, causes increase use of, or an increase in the size of, combined data space 115, which can correspondingly reduce the use of, or size of, remote data space 114, and result in increased unused space 116 beyond the space allocated for buffer space 117. Numerous other examples of different allocations can readily be appreciated, and all such allocations are to be considered within the scope of the instant disclosure even where not explicitly recited for the sake of clarity and brevity. It will be appreciated that the adaptation information can be a function of various metrics and determined values related to aspects comprising, for example, the available storage space, network traffic, component health, customer subscription information, business goals of a zone storage construct entity, etc. As a first example, an operator of a zone storage system can indicate, via a value, etc., that CRD space 113 should be at least a certain size, can indicate growing CRD space 113 according to cost parameters, etc. As a second example, a zone storage system subscriber agreement can indicate that the corresponding data chunks of the subscriber are ranked for storage in one or more of CRD 113, remote data 114, or combined data 115, according to the subscriber agreement, such that the subscriber data chunks are directed to the layers in a prescribed manner, whereby this prescribed manner can be employed by ZAC 130 to affect the process of determining adaptation information. As a third example, historical data, such as, historical network information, historical data recovery information, historical device health information, etc., data related to future changes, e.g., planned maintenance, planned zone growth, predicted or anticipated growth of regional storage markets, etc., can be employed to, for example, increase combined data space 115 and remote data space 114, while limiting local data space 112, to provide more remote data 142 storage, such as, where first ZSC 110 can operate at lower costs than another region, for example a data zone in Kansas can be cheaper to operate than a zone in Manhattan, thus it can be preferable to use Kansas over Manhattan for voluminous remote storage.

FIG. 2 is an illustration of example system states, e.g., states 200-208, for allocation of storage space for a storage zone of geographically diverse storage zones, in accordance with aspects of the subject disclosure. Example state 200 can illustrate first ZSC 211 comprising unused space 216. Unused space 216 can comprise an allocated buffer space 217. In an embodiment, state 200 can represent an initial state of first ZSC 211, e.g., where no local or remote data is stored on the available storage space of a corresponding first ZSC, e.g., first ZSC 110, etc.

Example state 202 can illustrate first ZSC 211A comprising an allocation of several types of storage space, e.g., via ZAC 130, etc., comprising space for local data 212A, unused space 216A comprising buffer space 217A, CRD 213A, and remote data 214A. As in state 200, unused space 216A, similar to unused space 216 comprising buffer space 217, can comprise buffer space 217A. In an embodiment, buffer space 217A can be the same or different from buffer space 217. In an aspect, allocation of space, such as is illustrated at state 202, etc., can allocate the size of the space, the location of portions of an allocated space on one or more data store(s), e.g., data store(s) 120-128, etc., or other aspects of the space. Accordingly, ZAC 130, for example, can allocate CRD 213A in state 202 as partially comprised of SSD space, partially comprised of fast hard drive space, partially comprised of RAM, etc., such that it can be expected that CRD 213A can access data stored in CRD 213A at a higher speed than might be associated with accessing data from remote data space 214A, e.g., where ZAC 130 allocated remote data 214A to medium speed hard drives, etc. In an embodiment, state 202 can represent at a ‘young’ state of first ZSC 211A, e.g., where first ZSC 211A in state 202 results from adaptation of allocated space, e.g., via ZAC 130, etc., as illustrated for first ZSC 211 in state 200.

Example state 204 can illustrate first ZSC 211B again comprising an allocation of several types of storage space, e.g., allocated via ZAC 130, etc. Unused space 216B, again similar to unused space 216 comprising buffer space 217, can comprise buffer space 217B. In an embodiment, buffer space 217B can be the same or different from buffer space 217, 217A, etc. In an aspect, allocation of space in state 204, e.g., via allocation by ZAC 130, etc., can reallocate CRD 213A, e.g., as partially comprising more or less of SSD space, fast hard drive space, RAM, etc., that can be the same or different from CRD 213A in state 202. Similarly, space and location of space comprising storage for local data 212B, unused space 216B, buffer space 217B, remote data 214B, combined data 215B, etc., can also be reallocated such that it is the same or different from the corresponding space(s) in state 202. As an example, local data 212B can be allocated more space in state 204 than local data 212A in state 202. In a further example, first ZSC logical storage space allocation 211B can comprise space for combined data 215B, e.g., for storing convolved data, etc., accordingly where the total space, for example remains static, space for remote data 214B can be reduced. In an embodiment, state 202 can represent at a ‘mature’ state of first ZSC 211A, e.g., where first ZSC 211B in state 204 can result from adaptation of allocated space, e.g., via ZAC 130, etc., as illustrated for first ZSC 211A in state 202.

Example state 206 can illustrate first ZSC 211C again comprising an allocation of several types of storage space, e.g., allocated via ZAC 130, etc. In an aspect, allocation of space in state 206, e.g., via allocation by ZAC 130, etc., can reallocate space for the different types of data, e.g., space and location of space comprising storage for local data 212C, buffer space 217C, CRD data 213C, remote data 214C, combined data 215C, etc., e.g., these space allocations can result from reallocation of the corresponding space(s) in state 204. As illustrated, at state 206, first ZSC logical storage space allocation 211C can have enough local data 212C and combined data 215C to deplete unused space, while still retaining buffer space 217C. Additional incoming remote data, e.g., remote data 142, etc., can be placed in the space for remote data 214C where other remote data in 214C is moved into either CRD 213C or combined with other data into combined data 215C, etc., can itself be combined with other data into the space allocated for combined data 215C, etc., where there is no remaining unused space in state 206. In an embodiment, state 206 can represent an ‘aging’ state of first ZSC 211C, e.g., where first ZSC 211C in state 206 can result from adaptation of allocated space, e.g., via ZAC 130, etc., as illustrated for first ZSC 211B in state 204.

Example state 208 can illustrate first ZSC 211D comprising an allocation of several types of storage space, e.g., allocated via ZAC 130, etc. In an aspect, allocation of space in state 208, e.g., via allocation by ZAC 130, etc., can reallocate space for the different types of data, e.g., space and location of space comprising storage for local data 212D, buffer space 217D, CRD data 213D, combined data 215D, etc., e.g., these space allocations can result from again allocating the corresponding space(s) in state 206. As illustrated, at state 208, first ZSC logical storage space allocation 211D can have enough local data 212D and combined data 215D to deplete unused space and space for remote data. Additional incoming remote data, e.g., remote data 142, etc., can be placed into either CRD 213D, can be combined with other data into combined data 215D, etc., where there is no remaining unused space or remote data space in state 208. In an embodiment, state 208 can represent an ‘elderly’ state of first ZSC 211D, e.g., where first ZSC 211D in state 208 can result from adaptation of allocated space, e.g., via ZAC 130, etc., as illustrated for first ZSC 211C in state 206. In an aspect, additional unused space can be added by adding additional data store(s) to a corresponding ZSC, which can allow a transition from state 208 to a state similar or the same as states 202-206.

A further state, not illustrated, can comprise space for local data, the buffer space, and combined data, resulting in incoming remote data, e.g., remote data 142, etc., being convolved into the space for combined data. This can result in growth of the space for combined data and forcing the reduction of the space for local data, or in some embodiments, invasion of the space allocated for the buffer. This state can be viewed as ‘full’. In an aspect similar to state 208, additional unused space can be added by adding additional data store(s) to a corresponding ZSC, which can allow a transition from state 208 to a state similar or the same as states 202-206.

The states illustrated in FIG. 2, can be reminiscent of geological layers exerting pressure on other geological layers, compressing them, and ‘squeezing out’ the unused space. Once the unused space has been squeezed out, compression of other geological layers can occur, analogous to formation of sedimentary stone layers from sand piling up in a river bed over many years. Similarly, the addition of more local and remote data to a zone can result in compressing the space available for storage of uncompressed non-local data, resulting in compression of received remote data into a combined data layer, and eventually, compression of, or even cessation of space allocation for, remote data and CRD layers. Unlike geological layers, however, additional space can simply be added, e.g., adding an additional storage device(s), to rejuvenate the logical allocation of storage space. Similarly, an allocation can comprise offloading combined data to other zones to rejuvenate the logical allocation of storage space.

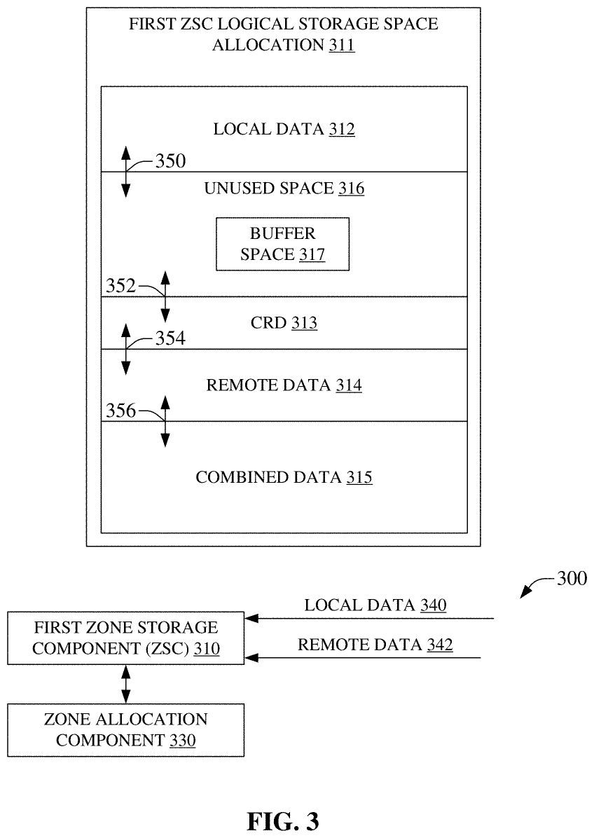

FIG. 3 is an illustration of a system 300, which can facilitate adapting an allocation of storage space for a storage zone of geographically diverse storage zones, in accordance with aspects of the subject disclosure. System 300 can comprise first ZSC 310. In some embodiments, first ZSC 310 can be similar to first ZSC 110, etc. First ZSC 310 can receive local data 340 and/or remote data 342. First ZSC 310 can then store received data, e.g., 340, 342, etc., on a data store on first ZSC 310. In an embodiment the storage of data on first ZSC 310 can be according to first ZSC logical storage space allocation 311. In an aspect, in response to information about first ZSC 310, ZAC 330 can determine an adaptation of allocation 311 and can trigger, cause, initiate, etc., a corresponding change to allocation 311.

First ZSC logical storage space allocation 311 can correspond to space and location of storage space for data stored via first ZSC 310. In an aspect, first ZSC logical storage space allocation 311 can comprise allocations of space for different classes of data, wherein the space can be allocated for storage of local data 312, unused space 316, buffer space 317, CRD 313, remote data 314, combined data 315, etc. In an aspect, adaptation of first ZSC logical storage space allocation 311 can be visualized similar to a hard disk partition tables where the boundary between different classes, types, etc., of data visually indicates an amount of space allocated to the corresponding class, type, etc. In an aspect, the ‘resizing’ of a space for storage of local data 312 under first ZSC logical storage space allocation 311 can be visualized as moving boundary 350 to make local data 312 larger or smaller. Less clear in this visualization is that the allocated storage space can be across one or more data store(s), e.g., data store(s) 120-128, etc., and can provide for use of data store(s) having indicated characteristics, e.g., local data 312 can be of a size corresponding to the boundary 350 and can allocate that space across one or more data store(s) having an indicated characteristic. As such the storage space does not need to be contiguous, on the same data store device, etc. As an example, local data 312 can be spread between two hard drives and that satisfy a rule indicating the hard drives should spin between 5400 and 7200 rpm. Other example rules, e.g., related to size, speed, reliability, age, location, brand, historical uptime, monetary cost, energy cost, etc., are readily appreciated and are within the scope of the instant disclosure even where not expressly recited for the sake of clarity and brevity. Similar to boundary 350, boundaries 352, 354, and 356 can each be adapted to indicate adaptation of storage size for the several classes, types, etc., of data stored via first ZSC logical storage space allocation 311. AS an example, boundary 356 354 and 352 can be moved towards boundary 350, corresponding to increasing the size of storage for combined data 315, keeping the size for local data 312, CRD 314, and remote data 314 static, and decreasing the size of space allocated to unused space 316. Of note, in some embodiments, unused space 316 can be held to be no smaller than the space allocated to buffer space 317.

FIG. 4 is an illustration of a system 400, which can enable rule based allocation of storage space for a storage zone of geographically diverse storage zones, in accordance with aspects of the subject disclosure. System 400 can comprise first ZSC 410 that can receive local data 440 and/or remote data 442. First ZSC 410 can comprise storage state component 460 that can determine information, e.g., a state, value, indicator, etc., related to storage of data on data store(s), e.g., data store(s) 120-128, etc., of first ZSC 410. In an embodiment, storage state component 460 can determine information pertaining to an allocation of storage space related to storing data at first ZSC 410, which information can comprise storage size, storage type, storage location, storage distribution, etc., of data at first ZSC 410. As an example, the allocation information that can be determined by storage state component 460 can indicate an amount of storage allocated to storing combined data, e.g., combined data 115, 215B, 215C, 215D, 315, etc., can indicate where the combined data is stored, e.g., a first portion is stored at determined locations on data store(s) 120, a second portion is stored at determined locations on data store(s) 122, etc., can determine that data stored in combined data is ‘cold data’, e.g., data that is ranked as unlikely to be regularly accessed in comparison to other data that can be stored in an area allocated to remote data (‘warm data’) or data stored in an area allocated for cached remote data (‘hot data’), etc. Other information pertaining to an allocation of storage space of first ZSC 410 are readily appreciated and are within the scope of the present disclosure despite not being recited for the sake of clarity and brevity only.

First ZSC 410 can comprise inter-zone traffic component 462 and/or intra-zone traffic component 464. In an embodiment inter-zone traffic component 462 and/or intra-zone traffic component 464 can determine information corresponding to network traffic associated with data stored via first ZSC 410. Inter-zone traffic component 462 can determine information related to network traffic between zones, wherein the zones comprise a first zone corresponding to first ZSC 410, e.g., inter-zone network traffic. This inter-zone network traffic can be related to the allocation of storage space related to first ZSC 410. In an aspect, data stored in a space allocated to combined data can increase inter-zone network traffic, for example, because accessing a data affiliated with a chunk that has been combined with another chunk can be dependent upon first deconvolving a combined/convolved chunk that comprises the data sought. As is disclosed herein, deconvolving a combined chunk, such as chunk AB, to access chunk A can be dependent on having chunk B to enable the deconvolution of chunk AB in to chunk A and chunk B. Accordingly, where example chunk B is not already accessible at first ZSC 410, chunk B must be received by first ZSC 410, which typically will correspond to consumption of network resources and thereby can increase network traffic associated with first ZSC 410. It will be noted, that in some embodiments, example chunk B can be received at first ZSC 410 via a modality other than a network, e.g., connecting hard drive, SSD, etc., to first ZSC 410 without using a network, etc., can allow first ZSC 410 to access chunk B without use of a network, although this technique can be less convenient and less efficient under normal circumstances than using a network, e.g., mailing a hard drive from one geographic location to another geographic location associated with first ZSC 410 can likely be much less convenient and efficient that simply copying chunk B over a network between the two zones to enable deconvolution of example chunk AB to recover chunk A.

In an aspect, reducing inter-network traffic can be desirable, e.g., can reduce network congestion, can reduce monetary cost by allowing use of less expensive lower bandwidth network connections, etc. However, storing remote chunks in an uncompressed format, e.g., as cached remote data or remote data rather than as combined data, can consume large amounts of storage space. As such, the demand on a network, e.g., network traffic, can be balanced against the demands of storing remoted data, e.g., 142, etc., in an unconvolved state via first ZSC 410. As such, inter-zone traffic component 462 can determine inter-zone network information that can, in some embodiments, be provided to ZAC 430 to facilitate determining an adaptation of space allocation, e.g., related to altering inter-zone network traffic by apportion space to either combined data storage space, which, for example, can increase inter-zone network traffic but can reduce consumed space, to remote data storage space that, for example, can reduce inter-zone network traffic but can increase space consumed to store copies of remote chunks, to cached remote data storage space that, for example, can reduce inter-zone network traffic but can increase space consumed at a zone and can further be associated, for example, with higher cost storage for faster access, etc.

Intra-zone network traffic can be related to data management within a zone. Intra-zone network traffic, for example, can increase when a chunk is moved into, or out of, a data store(s) location, such as can occur if a data chunk is moved out of a space for cached remote data to make room for incoming remote data, etc. It will be appreciated that allocating more space, in the preceding example, can reduce intra-zone network traffic by allowing space for the example incoming remote data to be stored in the coached remote data space without needing to first move out another chunk to make room for the incoming data chunk. Other zone operations can also relate to intra-zone network traffic affected by an allocation of storage space and all such embodiments are within the scope of the instant disclosure. In an aspect, reducing intra-network traffic can be desirable, e.g., can reduce intra-zone network congestion, can reduce monetary cost by reducing read/write events on data store(s) of a zone, etc. As such, a demand on a network, e.g., intra-network traffic, can be balanced against the demands of storing remoted data, e.g., 142, etc., via first ZSC 410. As such, intra-zone traffic component 464 can determine intra-zone network information that can, in some embodiments, be provided to ZAC 430 to facilitate determining an adaptation of space allocation, e.g., related to altering intra-zone network traffic by apportioning space in a manner tha can reduce intra-network traffic in view of space, cost, time, speed, or other zone characteristics.

System 400 can comprise ZAC 430, which can comprise data pressure analysis component 470, rule engine component 472, storage space allocation component 474, etc. ZAC 430 can be coupled to first ZSC 410 and can receive or transmit data to/from first ZSC 410, e.g., storage state information, inter-/intra-zone traffic information, etc. Data pressure analysis component 470 can analyze a first allocation of data storage space for first ZSC 410 to determine a pressure value associated with the allocation of storage space. A pressure value can correspond to balancing storage space for different types, classes, etc., of data stored via first ZSC 410. In an example, where a zone has ample unused space, the pressure value can be determined to indicate that there is no need to combine remote data because incoming remote data 142, etc., can simply be stored in an ever expanding remote data storage space while unused space does not transition a threshold value, e.g., if there is lots of space then there can be little need to convolve remote data chunks to save space and the remote data storage space can simply be expanded to accommodate newly received remote data chunks. However, where unused space transitions a threshold value, the pressure value can indicate that a remote data storage space should be limited to allow for space for combined data storage space, e.g., as free space is drawn down remote data chunks can be combined to reduce consumed storage space. Further, data pressure analysis component 470 can consider the pressure exerted by other types of data storage, e.g., where the zone increasingly stores more local data chunks, this can increase pressure on the finite amount of storage space, sans adding more data store(s) to the zone, and can be related to adapting space allocation to cause remote data to be combined and stored in a combined data storage area. In an aspect, even where the zone is not receiving new remote data chunks, increasing local data chunks can be associated with changing a storage allocation to allow more combined data generated from data chunks presently residing, for example, in a cached remote data store area, a remote data store area, etc. Additionally, where the zone is receiving new remote data chunks, changing a storage allocation to allow more combined data generated from either data chunks presently residing or newly arriving, e.g., in a cached remote data store area, a remote data store area, etc., can also result from a data pressure analysis.

Rule engine component 472 can synthesize, generate, adapt, delete, etc., rules related to determining an adaptation of an allocation of storage space related to first ZSC 410. In an aspect, a rule can be in the form of a function, e.g., storage space for a type of data storage can be a function of data pressure information, inter-/intra-network traffic information, or other information, such as, but not limited to, external traffic information 480, service agreement information 482, zone planning information 482, etc. In some embodiments, a rule can be based on a set of binary decisions, e.g., flow chart, etc. In some embodiments, rules can employ machine learning, etc., to determine an inference, e.g., a more or less likely outcome based on incoming information such that an adaptation of a storage space allocation can be responsive to the inference, e.g., where a rate of local data storage is steadily increasing, it can be inferred that the rate of change in can be stable over time albeit with increasing uncertainty for more distant times, such that an adaptation to an allocation of space can be predicted for an upcoming time when it can be inferred that the local space consumption will be better served by initiating the change in space allocation.

In an embodiment, external traffic information 480 can comprise information related to traffic between zones that may not comprise a first zone corresponding to first ZSC 410, for example where network traffic increases for other zones, such as in response to a natural disaster affecting a remote zone, this traffic information can be received by ZAC 430. This information can be used to adapt a storage allocation for the first zone where, for example, it can be inferred that because the first zone also comprises some back up data for the other impacted zone there can be an uptick in network traffic coming for the first zone, e.g., the first zone can be reallocated to proactively begin making space to deconvolve combined data into remote data space to improve a response to a request to provide copies of data chunks associated with the other impacted zone.

Service agreement information 482 can be information related to an agreement with an entity that stores data in a system comprising first ZSC 110. In an embodiment, a service agreement can indicate different levels of service for individual customers/users, e.g., a customer, for example, can pay a fee to have their data more accessible at a designated level. This level can be associated, for example, with a speed of access, etc. Data can be generally accessed faster where there are fewer operations between a request for the data of a stored data chunk and receiving the data of the stored data chunk and, as such, storing data in a cached remote data store can provide faster access to data, such as due to storage on faster access data store(s) components, such as solid state memory, faster hard drives, etc., than may be used for storage in a remote data storage area, which in turn can be faster to access than the same data in a combined data storage area that can be associated with first deconvolving a chunk to access data comprised in a convolved data chunk. In an aspect, service agreement information 482 can be employed by ZAC 430 in determining an adaptation of an allocation of storage space by providing storage space that comports with a customer agreement. In an example, where a customer pays for data to be stored for fastest access, an adaption of storage space allocation can enable sufficient storage space in a fast access data storage area, e.g., cached remote data storage area, etc., on data store(s) location(s) that employ faster communications modalities, etc.

Zone planning information 482 can be information related to anticipated changes to the zone, e.g., planned addition or removal data store(s) of a zone, planned changes/upgrades/downgrades to data stores of a zone, planned changes to inter-]intra-network services associated with the zone, planned maintenance down time, etc. As an example, where a zone maintenance plan indicates that a zone will have one data store device added and another data store device replaced, ZAC 430 can determine an adaptation to the storage allocation that provides sufficient storage space to move data from the data store that will be replaced to another data store before the data store device is replaced. Similarly, ZAC 430 can determine an adaptation to the storage space allocation that can be implemented once the storage device is replace and the new data storage device is added, e.g., the processing to determine the adaptation can be performed in advance of the change to the equipment comprising the zone such that the changes to the allocation can be more rapidly implemented upon completion of the example upgrades and maintenance.

Storage space allocation component 474 of ZAC 430 can determine an allocation of storage space, an adaptation of a current allocation of storage space, etc. In an aspect, a determination from space allocation component 474 can be based on information received by, or determined by, ZAC 430 in regard to first ZSC 410. In an embodiment, space allocation component 474 can determine an allocation of zone storage space based on a current allocation of the zone storage space, e.g., as can be indicated by information from storage state component 460, etc., data pressure information, network traffic, etc., information resulting from applying rules generated by rule engine component 472 to information germane to allocation of storage space via first ZSC 410, etc. ZAC 430 can initiate a change in a storage space allocation of a zone corresponding to first ZSC 410 based on the allocation, or adaptation of an allocation, determined by storage space allocation component 474.

FIG. 5 is an illustration of a system 500, which can enable allocation of storage space for a storage zone of geographically diverse storage zones, in accordance with aspects of the subject disclosure. System 500 can comprise first ZSC 510 that can receive local data and/or remote data. ZSC 510 can be part of a geographically diverse storage system comprising second ZSC 512, N-th ZSC 518, etc. First ZSC 510 can be communicatively coupled to other ZSCs, as illustrated.

System 500 can comprise ZAC 530, which can comprise data pressure analysis component 570, rule engine component 572, storage space allocation component 574, etc. ZAC 530 can be coupled to first ZSC 510, second ZSC 512, N-th ZSC 518, etc., and can receive or transmit data to/from the same, e.g., storage state information, inter-/intra-zone traffic information, etc. Data pressure analysis component 570 can analyze a first allocation of data storage space for one or more of the ZSCs, e.g., first ZSC 510, second ZSC 512, N-th ZSC 518, etc., to determine one or more pressure value associated with the allocation of storage space at one or more of the ZSCs. A pressure value can correspond to balancing storage space for different types, classes, etc., of data stored via a ZSC. Further, data pressure analysis component 570 can consider the pressure exerted by other types of data storage.

Rule engine component 572 can synthesize, generate, adapt, delete, etc., rules related to determining an adaptation of an allocation of storage space related to one or more of the ZSCs, e.g., first ZSC 510, second ZSC 512, N-th ZSC 518, etc. In an aspect, a rule can be in the form of a function, a rule can be based on a set of binary decisions, etc. In some embodiments, rules can employ machine learning, etc., to determine an inference enabling ZAC 530 to infer characteristics pertinent to the space allocation of a ZSC of the ZSCs.

Storage space allocation component 574 of ZAC 530 can determine an allocation of storage space, an adaptation of a current allocation of storage space, etc. In an aspect, a determination from space allocation component 574 can be based on information received by, or determined by, ZAC 530 in regard to one or more of the ZSCs, e.g., first ZSC 510, second ZSC 512, N-th ZSC 518, etc. In an embodiment, space allocation component 574 can determine an allocation of zone storage space based on a current allocation of the zone storage space, e.g., as can be indicated by information from storage state component 560, etc., data pressure information, network traffic, etc., information resulting from applying rules generated by rule engine component 572 to information germane to allocation of storage space a corresponding ZSC. ZAC 530 can initiate a change in a storage space allocation of a corresponding zone based on the allocation, or adaptation of an allocation, determined by storage space allocation component 574.

In an embodiment, external traffic information 580 can comprise information related to traffic between zones, e.g., first ZSC 510, second ZSC 512, N-th ZSC 518, etc., for example where network traffic increases for some zones, such as in response to a natural disaster affecting a remote zone, this traffic information can be received by ZAC 530. This information can be used to adapt a storage allocation for the one or more of first ZSC 510, second ZSC 512, N-th ZSC 518, etc. Service agreement information 582 can be information related to an agreement with an entity that stores data in a system comprising first ZSC 510, second ZSC 512, N-th ZSC 518, etc. In an embodiment, a service agreement can indicate different levels of service for individual customers/users, e.g., a customer, for example, can pay a fee to have their data more accessible at a designated level. In an aspect, service agreement information 582 can be employed by ZAC 530 in determining an adaptation of an allocation of storage space by providing storage space that comports with a customer agreement. Zone planning information 582 can be information related to anticipated changes to the zone, e.g., planned addition or removal data store(s) of a zone, planned changes/upgrades/downgrades to data stores of a zone, planned changes to inter-/intra-network services associated with the zone, planned maintenance down time, etc. Similarly, ZAC 530 can determine the adaptation in advance of a change to the zone such that the changes to the allocation can be more rapidly implemented upon completion of planned changes to the zone.

ZAC 530 can further determine adaptations to an allocation of storage space in a ZSC based on other information, such as, but not limited to, historical traffic pattern information 583, zone maintenance information 584, inter-zone load balancing information 585, etc. Historical traffic pattern information 583 can be information related to historical inter-/intra-network traffic patterns that can be used in determining an adaption to the storage space allocation. As an example, network traffic can historically be found to increase at certain times of year, e.g., at a fiscal year end there can be additional creation of financial data that can lead to filling of more data chunks than during another time of year, which additional data chunks, when backed up to a remote zone can cause an increase in network traffic. As another example, annual weather patterns can result in data recovery patterns that are associated with higher network traffic due to moving data chunks to allow for deconvolution of convolved data to recover data lost during the heavier weather periods. Zone maintenance information can relate to emergent zone maintenance, as can be distinct from planned zone maintenance, such as is described in regard to zone planning information 582, 482, etc. As an example, a loss of access to one or more data store(s) of a zone can be communicated to ZAC 530 in zone maintenance information 584, allowing ZAC 530 to determine an adaptation to a data storage allocation. Inter-zone load balancing information 585 can comprise information related to balancing of storage load between zones of a geographically distributed storage system. In an aspect, where use of one ZSC is disproportionate to other ZSC utilizations, ZAC 530 can adapt data storage space allocation. As an example, where first ZSC 510 has a high level of local data storage, remote data storage area can be adapted in a manner that results in new remote chunks being routed to other ZSCs, e.g., second ZSC 512, N-th ZSC 518, etc. In another example, where first ZSC 510 has less overall storage capacity than another ZSC, ZAC 530 can adapt first ZSC 510 data storage space allocation such that, for example, combined chunks are moved to other zone in a manner germane to the convolution modality and germane to the design of the geographically diverse storage system, e.g., ZAC 530 can determine an adaptation that results in moving data to other more space available zones where it doesn't compromise the integrity of the geographically diverse storage construct.

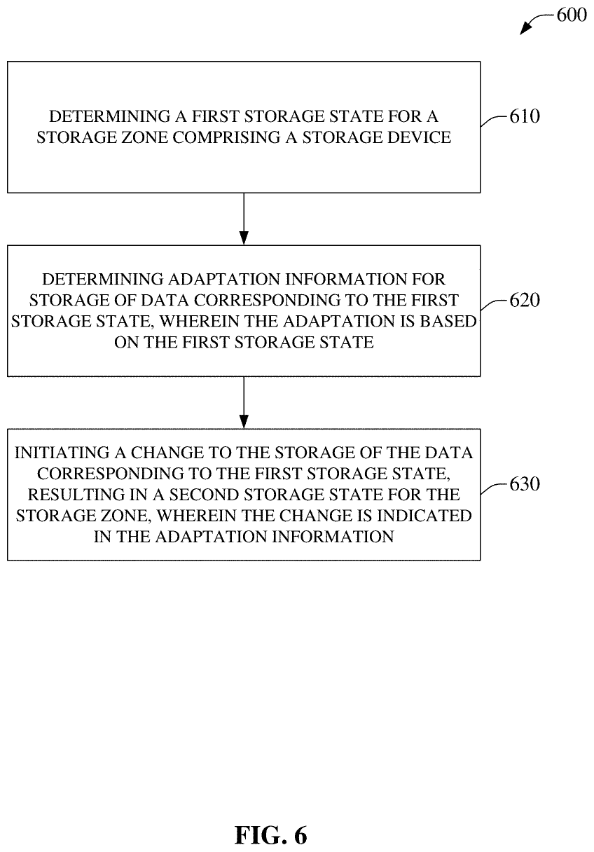

FIG. 6 is an illustration of an example method 600, which can facilitate allocation of storage space for a storage zone of geographically diverse storage zones of a geographically diverse storage construct, in accordance with aspects of the subject disclosure. At 610, method 600 can comprise determining a first storage state for a storage zone of a storage device of a geographically diverse storage system. The first storage state can represent an amount of space and, in some embodiments, locations of storage for one or more types of data storage. In an aspect, the space for different types of data storage can be located on one or more data store(s), e.g., data store(s) 120-128, etc. In another aspect, the space allocated for each type of data storage can be the same or different from a space allocated for storing a different type of data, for example, as is illustrated for first ZSC logical storage space allocation 111. Storage for different types, or classes, etc., of data can comprise local data, e.g., 112, etc., unused space 116, etc., buffer space 117, etc., cached remote data 113, etc., remote data 114, etc., combined data 115, etc., among others. In an aspect, the storage space allocated for a type of data can be employed for storing data of that type. The allocated space for a type of data can, in some embodiments, be larger than an amount of data stored therein, or in some embodiments be the same as the amount of data stored therein, e.g., if an allocation has 400 TB allocated for local data, up to 400 TB of data can be stored in that storage space. Moreover, the 400 TB of space can be spread across one or more data store(s). In some embodiments, the allocation can track the amount of data stored in that storage space, such that if there is 175 TB of local data, then approximately 175 TB of storage space is allocated to that type of data storage, noting that the type of storage medium is generally incremental and the size of the allocated space will generally comprise sufficient increments of storage for a given type of storage medium to accommodate the amount of data to be stored often resulting in slightly more space being allocated, e.g., if the increment size is 16 TB, then to store 175 TB of local data, then 11 increments of storage equaling 176 TB of storage can be allocated.

At 620, method 600 can comprise determining adaptation information for storage of data corresponding to the first storage state. Adaptation information can be based on the first storage state, for example, where the first storage state indicates that there is no remaining unused space, other than a reserved buffer space, then an adaptation can be to increase a storage space of combined data and to reduce a storage space of remote data, thereby allowing combining of some remote data into the space for combined data to allow newly arriving remote data to be stored in the space vacated in the remote data space resulting from the combing operation. In some embodiments, the adaptation information can further be based on other information, indicators, values, metrics, etc. As an example, adaptation information can be based on the first storage state and an indication of inter-network traffic volume. As a further example, adaptation information can be based on the first storage state and an indication of planned zone maintenance. As a further example, adaptation information can be based on the first storage state and a determined data pressure value.

At 630, method 600 can comprise initiating a change to the storage of data corresponding to the first storage state. At this point, method 600 can end. The change can be indicated in the adaptation information determined at 620. The initiated change can result in a second storage state for the storage zone. In an aspect, the determining the adaption information at 620 can, in some situations, generate adaptation information indicating that no change is to be initiated at 630. In an embodiment, the determining the adaptation information can be in response to receiving information, e.g. ZAC 130, etc., receiving information such as is disclosed elsewhere herein, for example, ZAC 430 receiving inter-/intra-zone traffic information, etc. In some embodiments, the determining the adaptation information can be in response to determining information related to the storage of data by a device of a geographically diverse storage system, e.g. ZAC 130, etc., determining a data pressure value by data pressure analysis component 470, determining a result from application of a rule generated by rule engine component 472, etc., such as is disclosed elsewhere herein.

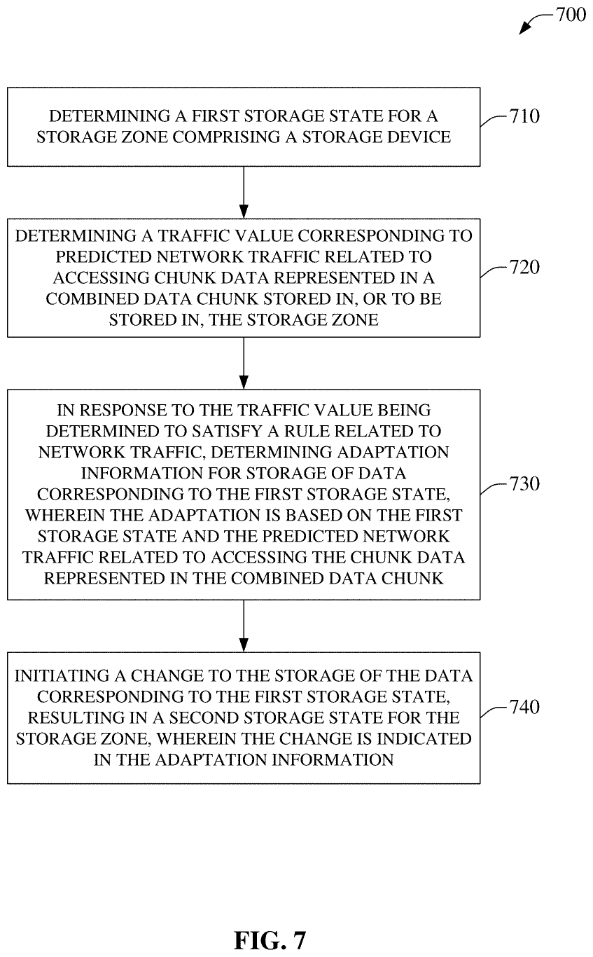

FIG. 7 is an illustration of an example method 700, which can facilitate network traffic sensitive allocation of storage space for a storage zone of geographically diverse storage zones, in accordance with aspects of the subject disclosure. At 710, method 700 can comprise determining a first storage state for a storage zone of a storage device of a geographically diverse storage system. The first storage state can represent an amount of space and, in some embodiments, locations of storage for one or more types of data storage. In an aspect, the space for different types of data storage can be located on one or more data store(s), e.g., data store(s) 120-128, etc. In another aspect, the space allocated for each type of data storage can be the same or different from a space allocated for storing a different type of data. In an aspect, the storage space allocated for a type of data can be employed for storing data of that type.

At 720, method 700 can comprise determining a traffic value corresponding to predicted network traffic related to access chunk data represented in a combined data chunk, e.g., related to deconvolving a combined data chunk. In an embodiment, the combined data chunk can be stored in the storage zone. In these embodiments, the combined chunk can reside in a storage space of a zone designated/allocated for storing combined data chunks. In another embodiment, the combined data chunk can be expected to be stored in the storage zone. In these embodiments, chunks that can be convolved to form the combined data chunk can reside in a space for remote data in anticipation of being moved, via convolution, into a storage space for a combined data chunk, thereby allowing adaption of a storage space allocation prior to initiating actual use of the corresponding storage space.

At 730, method 700 can comprise determining adaptation information for storage of data corresponding to the first storage state. The determining the adaptation information can be in response to the traffic value being determined to satisfy a rule related to network traffic. As an example, where the traffic value indicates a sufficiently significant elevation in, for example, inter-zone network traffic, e.g., satisfying the rule, this can result in the determining the adaptation information, for example, to increase storage space for remote data so that the remote data can be stored without being convolved in an effort to forestall the predicted increase in inter-zone network traffic. Adaptation information can be based on the first storage state and the predicted traffic network traffic related to accessing the chunk data represented in the combined data chunk. In some embodiments, the adaptation information can further be based on other information, indicators, values, metrics, etc.

At 740, method 700 can comprise initiating a change to the storage of the data corresponding to the first storage state. At this point, method 700 can end. The change can be indicated in the adaptation information determined at 730. The initiated change can result in a second storage state for the storage zone. In an aspect, the determining the adaption information at 730 can, in some situations, generate adaptation information indicating that no change is to be initiated at 740. In an embodiment, the determining the adaptation information can be in response to receiving information, e.g. by ZAC 130, etc., such as is disclosed elsewhere herein, for example, ZAC 430 receiving inter-/intra-zone traffic information, etc. In some embodiments, the determining the adaptation information can be in response to determining information related to the storage of data by a device of a geographically diverse storage system, e.g. ZAC 130, etc., determining a data pressure value via data pressure analysis component 470, determining a result from application of a rule generated by rule engine component 472, etc., such as is disclosed elsewhere herein.

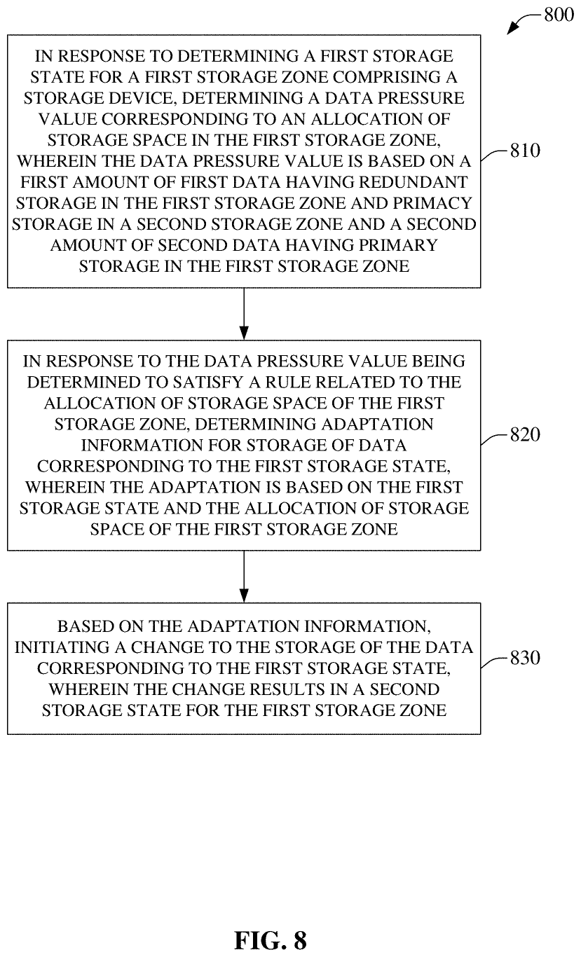

FIG. 8 is an illustration of an example method 800, which can enable data pressure sensitive allocation of storage space for a storage zone of geographically diverse storage zones, in accordance with aspects of the subject disclosure. At 810, method 800 can comprise determining a data pressure value in response to determining a first storage state for a storage zone of a storage device of a geographically diverse storage system. The first storage state can represent an amount of space and, in some embodiments, locations of storage for one or more types of data storage. In an aspect, the space for different types of data storage can be located on one or more data store(s), e.g., data store(s) 120-128, etc. In another aspect, the space allocated for each type of data storage can be the same or different from a space allocated for storing a different type of data. In an aspect, the storage space allocated for a type of data can be employed for storing data of that type.

The data pressure value can correspond to an allocation of storage space in the first storage zone. The data pressure value can be based on a first amount of first data having redundant storage in the first storage zone and primary storage in a second storage zone, e.g., remote data such as remote data 142, 342, 442, etc., and a second amount of second data having primary storage in the first storage zone, e.g., local data such as local data 140, 340, 440, etc. In an embodiment, where space consumed by local data is altered and/or space consumed by combined data is altered, this can consume more/less of the total space. Where, in the example, there is sufficient unused space, there can be little data pressure and additional space can generally be readily allocated for storing and increasing volume of local data and/or additional space can generally be readily allocated for storing an increasing volume of combined data. However, in the example, where unused space is not readily available, such as in storage states having space allocated to storing remote data and to storing combined data, changes in the volume of stored local or combined data can come at the cost of storing less uncombined remote data. Accordingly, this can result in increased data pressure. The increased data pressure can be relieved by reallocating the storage space, e.g., determining an adaptation to the first storage state.

At 820, method 800 can comprise determining adaptation information for storage of data corresponding to the first storage state. The determining the adaptation information can be in response to the data pressure value being determined to satisfy a rule related to the allocation of storage space of the first storage zone. Adaptation information can be based on the first storage state and the allocation of storage space of the first storage zone, e.g., changes to the allocation of storage space of the first storage zone can result in reducing data pressure, see FIG. 3, etc. In some embodiments, the adaptation information can further be based on other information, indicators, values, metrics, etc.

At 830, method 800 can comprise initiating a change to the storage of the data corresponding to the first storage state. At this point, method 800 can end. The change can be indicated in the adaptation information determined at 830. The initiated change can result in a second storage state for the storage zone. In an aspect, the determining the adaption information at 820 can, in some situations, generate adaptation information indicating that no change is to be initiated at 830. In an embodiment, the determining the adaptation information can be in response to receiving information, e.g. by ZAC 130, etc., such as is disclosed elsewhere herein, for example, ZAC 430 receiving inter-/intra-zone traffic information, etc. In some embodiments, the determining the adaptation information can be in response to determining information related to the storage of data by a device of a geographically diverse storage system, e.g. ZAC 130, etc., determining a data pressure value via data pressure analysis component 470, determining a result from application of a rule generated by rule engine component 472, etc., such as is disclosed elsewhere herein.

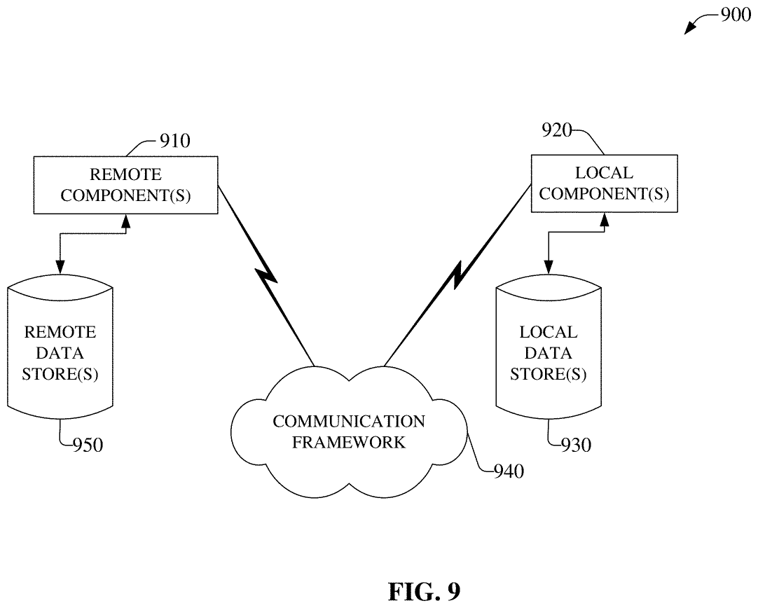

FIG. 9 is a schematic block diagram of a computing environment 900 with which the disclosed subject matter can interact. The system 900 comprises one or more remote component(s) 910. The remote component(s) 910 can be hardware and/or software (e.g., threads, processes, computing devices). In some embodiments, remote component(s) 910 can be a remotely located ZSC connected to a local ZSC via communication framework 940. ZAC 130, 330, 430, 530, etc., can also be remote component(s) 910 where located remotely from a local component, for example, from ZSC 110, 310, 410, 510-518, etc. Communication framework 940 can comprise wired network devices, wireless network devices, mobile devices, wearable devices, radio access network devices, gateway devices, femtocell devices, servers, etc.

The system 900 also comprises one or more local component(s) 920. The local component(s) 920 can be hardware and/or software (e.g., threads, processes, computing devices). In some embodiments, local component(s) 920 can comprise a local ZSC connected to a remote ZSC via communication framework 940. In an aspect the remotely located ZSC or local ZSC can be embodied in ZSC 110, 310, 410, 510-518, etc.

One possible communication between a remote component(s) 910 and a local component(s) 920 can be in the form of a data packet adapted to be transmitted between two or more computer processes. Another possible communication between a remote component(s) 910 and a local component(s) 920 can be in the form of circuit-switched data adapted to be transmitted between two or more computer processes in radio time slots. The system 900 comprises a communication framework 940 that can be employed to facilitate communications between the remote component(s) 910 and the local component(s) 920, and can comprise an air interface, e.g., Uu interface of a UMTS network, via a long-term evolution (LTE) network, etc. Remote component(s) 910 can be operably connected to one or more remote data store(s) 950, such as a hard drive, solid state drive, SIM card, device memory, etc., that can be employed to store information on the remote component(s) 910 side of communication framework 940. Similarly, local component(s) 920 can be operably connected to one or more local data store(s) 930, that can be employed to store information on the local component(s) 920 side of communication framework 940. As examples, information corresponding to chunks stored on ZSCs can be communicated via communication framework 940 to other ZSCs of a storage network, e.g., to facilitate compression, storage in partial or complete chunks, deletion of chunks, etc., on/from a ZSC as disclosed herein, information can be communicated between a ZSC, e.g., ZSC 110, etc., and a ZAC, e.g., ZAC 130, etc. to allow for determining an adaptation and initiating a change to an allocation based on the determined adaption, etc.

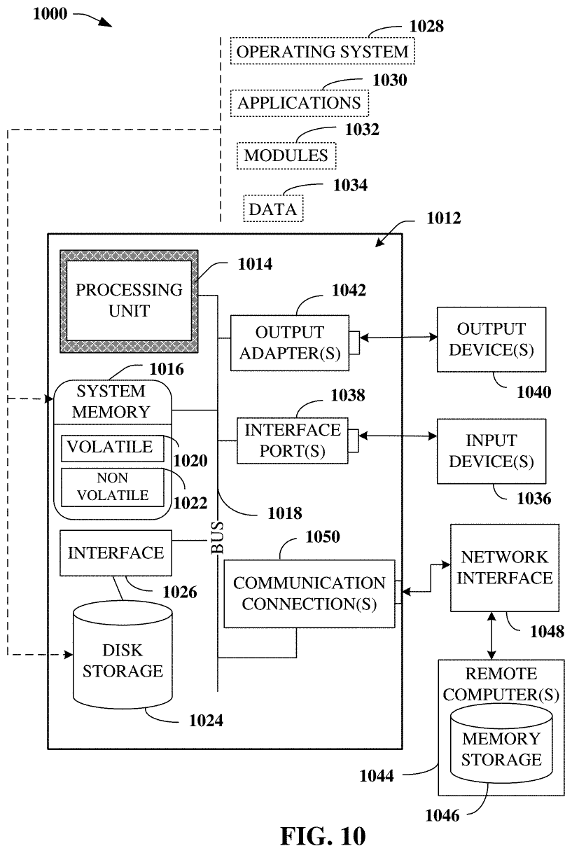

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the disclosed subject matter also can be implemented in combination with other program modules. Generally, program modules comprise routines, programs, components, data structures, etc. that performs particular tasks and/or implement particular abstract data types.

In the subject specification, terms such as “store,” “storage,” “data store,” data storage,” “database,” and substantially any other information storage component relevant to operation and functionality of a component, refer to “memory components,” or entities embodied in a “memory” or components comprising the memory. It is noted that the memory components described herein can be either volatile memory or nonvolatile memory, or can comprise both volatile and nonvolatile memory, by way of illustration, and not limitation, volatile memory 1020 (see below), non-volatile memory 1022 (see below), disk storage 1024 (see below), and memory storage 1046 (see below). Further, nonvolatile memory can be included in read only memory, programmable read only memory, electrically programmable read only memory, electrically erasable read only memory, or flash memory. Volatile memory can comprise random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, SynchLink dynamic random access memory, and direct Rambus random access memory. Additionally, the disclosed memory components of systems or methods herein are intended to comprise, without being limited to comprising, these and any other suitable types of memory.

Moreover, it is noted that the disclosed subject matter can be practiced with other computer system configurations, comprising single-processor or multiprocessor computer systems, mini-computing devices, mainframe computers, as well as personal computers, hand-held computing devices (e.g., personal digital assistant, phone, watch, tablet computers, netbook computers, . . . ), microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

FIG. 10 illustrates a block diagram of a computing system 1000 operable to execute the disclosed systems and methods in accordance with an embodiment. Computer 1012, which can be, for example, comprised in a ZSC 110, 310, 410, 510-518, etc., comprised in ZAC 130, 330, 430, 530, etc., or in other components, such as data store(s) 120-128, etc., can comprise a processing unit 1014, a system memory 1016, and a system bus 1018. System bus 1018 couples system components comprising, but not limited to, system memory 1016 to processing unit 1014. Processing unit 1014 can be any of various available processors. Dual microprocessors and other multiprocessor architectures also can be employed as processing unit 1014.

System bus 1018 can be any of several types of bus structure(s) comprising a memory bus or a memory controller, a peripheral bus or an external bus, and/or a local bus using any variety of available bus architectures comprising, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (Institute of Electrical and Electronics Engineers 1194), and small computer systems interface.

System memory 1016 can comprise volatile memory 1020 and nonvolatile memory 1022. A basic input/output system, containing routines to transfer information between elements within computer 1012, such as during start-up, can be stored in nonvolatile memory 1022. By way of illustration, and not limitation, nonvolatile memory 1022 can comprise read only memory, programmable read only memory, electrically programmable read only memory, electrically erasable read only memory, or flash memory. Volatile memory 1020 comprises read only memory, which acts as external cache memory. By way of illustration and not limitation, read only memory is available in many forms such as synchronous random access memory, dynamic read only memory, synchronous dynamic read only memory, double data rate synchronous dynamic read only memory, enhanced synchronous dynamic read only memory, SynchLink dynamic read only memory, Rambus direct read only memory, direct Rambus dynamic read only memory, and Rambus dynamic read only memory.

Computer 1012 can also comprise removable/non-removable, volatile/non-volatile computer storage media. FIG. 10 illustrates, for example, disk storage 1024. Disk storage 1024 comprises, but is not limited to, devices like a magnetic disk drive, floppy disk drive, tape drive, flash memory card, or memory stick. In addition, disk storage 1024 can comprise storage media separately or in combination with other storage media comprising, but not limited to, an optical disk drive such as a compact disk read only memory device, compact disk recordable drive, compact disk rewritable drive or a digital versatile disk read only memory. To facilitate connection of the disk storage devices 1024 to system bus 1018, a removable or non-removable interface is typically used, such as interface 1026.

Computing devices typically comprise a variety of media, which can comprise computer-readable storage media or communications media, which two terms are used herein differently from one another as follows.

Computer-readable storage media can be any available storage media that can be accessed by the computer and comprises both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can comprise, but are not limited to, read only memory, programmable read only memory, electrically programmable read only memory, electrically erasable read only memory, flash memory or other memory technology, compact disk read only memory, digital versatile disk or other optical disk storage, magnetic cassettes, magnetic tape, magnetic disk storage or other magnetic storage devices, or other tangible media which can be used to store desired information. In this regard, the term “tangible” herein as may be applied to storage, memory or computer-readable media, is to be understood to exclude only propagating intangible signals per se as a modifier and does not relinquish coverage of all standard storage, memory or computer-readable media that are not only propagating intangible signals per se. In an aspect, tangible media can comprise non-transitory media wherein the term “non-transitory” herein as may be applied to storage, memory or computer-readable media, is to be understood to exclude only propagating transitory signals per se as a modifier and does not relinquish coverage of all standard storage, memory or computer-readable media that are not only propagating transitory signals per se. Computer-readable storage media can be accessed by one or more local or remote computing devices, e.g., via access requests, queries or other data retrieval protocols, for a variety of operations with respect to the information stored by the medium. As such, for example, a computer-readable medium can comprise executable instructions stored thereon that, in response to execution, can cause a system comprising a processor to perform operations, comprising receiving a first storage allocation corresponding to storage of data in a first zone, e.g., ZSC 110, 310, 410, etc., of a geographically diverse data storage system, determining adaptation information, e.g., via ZAC 130, 330, 430, etc., based on the first storage allocation being determined to satisfy a rule related to allocation of storage space, and initiating a change to the storage of data based on the adaptation information, as disclosed herein.

Communications media typically embody computer-readable instructions, data structures, program modules or other structured or unstructured data in a data signal such as a modulated data signal, e.g., a carrier wave or other transport mechanism, and comprises any information delivery or transport media. The term “modulated data signal” or signals refers to a signal that has one or more of its characteristics set or changed in such a manner as to encode information in one or more signals. By way of example, and not limitation, communication media comprise wired media, such as a wired network or direct-wired connection, and wireless media such as acoustic, RF, infrared and other wireless media.

It can be noted that FIG. 10 describes software that acts as an intermediary between users and computer resources described in suitable operating environment 1000. Such software comprises an operating system 1028. Operating system 1028, which can be stored on disk storage 1024, acts to control and allocate resources of computer system 1012. System applications 1030 take advantage of the management of resources by operating system 1028 through program modules 1032 and program data 1034 stored either in system memory 1016 or on disk storage 1024. It is to be noted that the disclosed subject matter can be implemented with various operating systems or combinations of operating systems.

A user can enter commands or information into computer 1012 through input device(s) 1036. In some embodiments, a user interface can allow entry of user preference information, etc., and can be embodied in a touch sensitive display panel, a mouse/pointer input to a graphical user interface (GUI), a command line controlled interface, etc., allowing a user to interact with computer 1012. Input devices 1036 comprise, but are not limited to, a pointing device such as a mouse, trackball, stylus, touch pad, keyboard, microphone, joystick, game pad, satellite dish, scanner, TV tuner card, digital camera, digital video camera, web camera, cell phone, smartphone, tablet computer, etc. These and other input devices connect to processing unit 1014 through system bus 1018 by way of interface port(s) 1038. Interface port(s) 1038 comprise, for example, a serial port, a parallel port, a game port, a universal serial bus, an infrared port, a Bluetooth port, an IP port, or a logical port associated with a wireless service, etc. Output device(s) 1040 use some of the same type of ports as input device(s) 1036.

Thus, for example, a universal serial busport can be used to provide input to computer 1012 and to output information from computer 1012 to an output device 1040. Output adapter 1042 is provided to illustrate that there are some output devices 1040 like monitors, speakers, and printers, among other output devices 1040, which use special adapters. Output adapters 1042 comprise, by way of illustration and not limitation, video and sound cards that provide means of connection between output device 1040 and system bus 1018. It should be noted that other devices and/or systems of devices provide both input and output capabilities such as remote computer(s) 1044.

Computer 1012 can operate in a networked environment using logical connections to one or more remote computers, such as remote computer(s) 1044. Remote computer(s) 1044 can be a personal computer, a server, a router, a network PC, cloud storage, a cloud service, code executing in a cloud-computing environment, a workstation, a microprocessor-based appliance, a peer device, or other common network node and the like, and typically comprises many or all of the elements described relative to computer 1012. A cloud computing environment, the cloud, or other similar terms can refer to computing that can share processing resources and data to one or more computer and/or other device(s) on an as needed basis to enable access to a shared pool of configurable computing resources that can be provisioned and released readily. Cloud computing and storage solutions can store and/or process data in third-party data centers which can leverage an economy of scale and can view accessing computing resources via a cloud service in a manner similar to a subscribing to an electric utility to access electrical energy, a telephone utility to access telephonic services, etc.

For purposes of brevity, only a memory storage device 1046 is illustrated with remote computer(s) 1044. Remote computer(s) 1044 is logically connected to computer 1012 through a network interface 1048 and then physically connected by way of communication connection 1050. Network interface 1048 encompasses wire and/or wireless communication networks such as local area networks and wide area networks. Local area network technologies comprise fiber distributed data interface, copper distributed data interface, Ethernet, Token Ring and the like. Wide area network technologies comprise, but are not limited to, point-to-point links, circuit-switching networks like integrated services digital networks and variations thereon, packet switching networks, and digital subscriber lines. As noted below, wireless technologies may be used in addition to or in place of the foregoing.

Communication connection(s) 1050 refer(s) to hardware/software employed to connect network interface 1048 to bus 1018. While communication connection 1050 is shown for illustrative clarity inside computer 1012, it can also be external to computer 1012. The hardware/software for connection to network interface 1048 can comprise, for example, internal and external technologies such as modems, comprising regular telephone grade modems, cable modems and digital subscriber line modems, integrated services digital network adapters, and Ethernet cards.

The above description of illustrated embodiments of the subject disclosure, comprising what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as those skilled in the relevant art can recognize.

In this regard, while the disclosed subject matter has been described in connection with various embodiments and corresponding Figures, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

As it employed in the subject specification, the term “processor” can refer to substantially any computing processing unit or device comprising, but not limited to comprising, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions described herein. Processors can exploit nano-scale architectures such as, but not limited to, molecular and quantum-dot based transistors, switches and gates, in order to optimize space usage or enhance performance of user equipment. A processor may also be implemented as a combination of computing processing units.

As used in this application, the terms “component,” “system,” “platform,” “layer,” “selector,” “interface,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, a program, and/or a computer. By way of illustration and not limitation, both an application running on a server and the server can be a component. One or more components may reside within a process and/or thread of execution and a component may be localized on one computer and/or distributed between two or more computers. In addition, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software or a firmware application executed by a processor, wherein the processor can be internal or external to the apparatus and executes at least a part of the software or firmware application. As yet another example, a component can be an apparatus that provides specific functionality through electronic components without mechanical parts, the electronic components can comprise a processor therein to execute software or firmware that confers at least in part the functionality of the electronic components.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form. Moreover, the use of any particular embodiment or example in the present disclosure should not be treated as exclusive of any other particular embodiment or example, unless expressly indicated as such, e.g., a first embodiment that has aspect A and a second embodiment that has aspect B does not preclude a third embodiment that has aspect A and aspect B. The use of granular examples and embodiments is intended to simplify understanding of certain features, aspects, etc., of the disclosed subject matter and is not intended to limit the disclosure to said granular instances of the disclosed subject matter or to illustrate that combinations of embodiments of the disclosed subject matter were not contemplated at the time of actual or constructive reduction to practice.

Further, the term “include” is intended to be employed as an open or inclusive term, rather than a closed or exclusive term. The term “include” can be substituted with the term “comprising” and is to be treated with similar scope, unless otherwise explicitly used otherwise. As an example, “a basket of fruit including an apple” is to be treated with the same breadth of scope as, “a basket of fruit comprising an apple.”

Furthermore, the terms “user,” “subscriber,” “customer,” “consumer,” “prosumer,” “agent,” and the like are employed interchangeably throughout the subject specification, unless context warrants particular distinction(s) among the terms. It should be appreciated that such terms can refer to human entities, machine learning components, or automated components (e.g., supported through artificial intelligence, as through a capacity to make inferences based on complex mathematical formalisms), that can provide simulated vision, sound recognition and so forth.

Aspects, features, or advantages of the subject matter can be exploited in substantially any, or any, wired, broadcast, wireless telecommunication, radio technology or network, or combinations thereof. Non-limiting examples of such technologies or networks comprise broadcast technologies (e.g., sub-Hertz, extremely low frequency, very low frequency, low frequency, medium frequency, high frequency, very high frequency, ultra-high frequency, super-high frequency, extremely high frequency, terahertz broadcasts, etc.); Ethernet; X.25; powerline-type networking, e.g., Powerline audio video Ethernet, etc.; femtocell technology; Wi-Fi; worldwide interoperability for microwave access; enhanced general packet radio service; second generation partnership project (2G or 2GPP); third generation partnership project (3G or 3GPP); fourth generation partnership project (4G or 4GPP); long term evolution (LTE); fifth generation partnership project (5G or 5GPP); third generation partnership project universal mobile telecommunications system; third generation partnership project 2; ultra mobile broadband; high speed packet access; high speed downlink packet access; high speed uplink packet access; enhanced data rates for global system for mobile communication evolution radio access network; universal mobile telecommunications system terrestrial radio access network; or long term evolution advanced. As an example, a millimeter wave broadcast technology can employ electromagnetic waves in the frequency spectrum from about 30 GHz to about 300 GHz. These millimeter waves can be generally situated between microwaves (from about 1 GHz to about 30 GHz) and infrared (IR) waves, and are sometimes referred to extremely high frequency (EHF). The wavelength (λ) for millimeter waves is typically in the 1-mm to 10-mm range.

The term “infer” or “inference” can generally refer to the process of reasoning about, or inferring states of, the system, environment, user, and/or intent from a set of observations as captured via events and/or data. Captured data and events can include user data, device data, environment data, data from sensors, sensor data, application data, implicit data, explicit data, etc. Inference, for example, can be employed to identify a specific context or action, or can generate a probability distribution over states of interest based on a consideration of data and events. Inference can also refer to techniques employed for composing higher-level events from a set of events and/or data. Such inference results in the construction of new events or actions from a set of observed events and/or stored event data, whether the events, in some instances, can be correlated in close temporal proximity, and whether the events and data come from one or several event and data sources. Various classification schemes and/or systems (e.g., support vector machines, neural networks, expert systems, Bayesian belief networks, fuzzy logic, and data fusion engines) can be employed in connection with performing automatic and/or inferred action in connection with the disclosed subject matter.

What has been described above includes examples of systems and methods illustrative of the disclosed subject matter. It is, of course, not possible to describe every combination of components or methods herein. One of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

What is claimed is:

1. A system, comprising:
a processor; and
a memory that stores executable instructions that, when executed by the processor, facilitate performance of operations, comprising:
receiving a first storage allocation corresponding to storage of data in a first zone of a geographically diverse data storage system;
determining adaptation information based on the first storage allocation being determined to satisfy a rule related to allocation of storage space; and
initiating a change to the storage of data based on the adaptation information.

2. The system of claim 1, wherein the first zone is a different zone than a second zone of the geographically diverse storage system, and wherein the first zone stores, on a first storage component, first information in a first data chunk to replicate second information represented in a second data chunk stored on a second storage component of the second zone.

3. The system of claim 2, wherein the first data chunk is a first convolved data chunk, and wherein the first convolved data chunk convolves the first information with third information represented in a third data chunk.

4. The system of claim 3, wherein the third data chunk is stored on the second storage component of the second zone of the geographically diverse data storage system.

5. The system of claim 3, wherein the third data chunk is stored on a third storage component of a third zone of the geographically diverse data storage system.

6. The system of claim 3, wherein the first convolved data chunk convolves the first information with the third information represented in the third data chunk results via an XOR operation.

7. The system of claim 1, wherein the determining adaptation information is further based on a first amount of a first type of a first portion of the data and a second amount of a second type of a second portion of the data.

8. The system of claim 7, wherein the determining adaptation information is further based on a determined data pressure value representing a correlation between the first amount, the second amount, and a total amount of storage for the first zone of the geographically diverse data storage system.

9. The system of claim 1, wherein the determining adaptation information is further based on an amount of inter-zone network usage between the first zone and at least a second zone of the geographically diverse data storage system.

10. The system of claim 1, wherein the determining adaptation information is further based on an amount of intra-zone network usage between a first data store of the first zone and a second data store of the first zone.

11. A method, comprising:
in response to receiving first information indicating a first storage allocation of first data in a first zone of a geographically diverse data storage system, generating, by a system comprising a processor and a memory, change information based on a first amount of a first type of a first portion of the first data and a second amount of a second type of a second portion of the first data; and
triggering, by the system, a change to the first storage allocation of the first data in the first zone based on the change information.

12. The method of claim 11, wherein the generating the change information is further based on a correlation between the first amount, the second amount, and a total amount of storage for the first zone of the geographically diverse data storage system.

13. The method of claim 11, wherein the generating the change information is further based on an amount of inter-zone network traffic between the first zone and at least a second zone of the geographically diverse data storage system.

14. The method of claim 11, wherein the generating the change information is further based on an amount of intra-zone network usage between a first data store of the first zone and a second data store of the first zone.

15. The method of claim 11, wherein the generating the change information corresponds to causing a first resizing a first storage area for local data chunks, a second resizing of a second storage area for combined data chunks, and a third resizing of a third storage area for another type of data chunk.

16. The method of claim 15, wherein the resizing of the second storage area for combined data chunks enables storage of a convolved chunk, and wherein a convolution of chunks resulting in the convolved chunk is accomplished via an XOR procedure.

17. The method of claim 11, wherein the change information is first change information, wherein the change is a first change, and further comprising in response to receiving second information indicating a third storage allocation of second data in a third zone of the geographically diverse data storage system, generating, by the system, second change information based on a third amount of the first type of a third portion of the second data and a fourth amount of the second type of a fourth portion of the second data; and
triggering, by the system, a second change to the second storage allocation of the second data in the second zone based on the second change information.

18. A machine-readable storage medium, comprising executable instructions that, when executed by a processor, facilitate performance of operations, comprising:
determining an adaptation of a storage allocation state corresponding to storage of data across one or more data stores of a first zone of a geographically diverse storage system, wherein the geographically diverse storage system further comprises at least a second zone and a third zone that are different than the first zone, and wherein the adaptation is based on an amount of a first type of a first portion of the data and an amount of a second type of a second portion of the data; and
communicating information to a device of the first zone, resulting in initiation of the adaptation of the storage allocation state.

19. The machine-readable storage medium of claim 18, wherein the first type of the first portion of the data is a combined data chunk type and the first portion of the data comprises a combined data chunk comprising information that is duplicative of a first data chunk stored on the second zone and a third data chunk stored on the third zone.

20. The machine-readable storage medium of claim 19, wherein the combined data chunk is a result of performing an XOR procedure based on a replica of the first data chunk stored at the first zone and a replica of the third data chunk stored at the first zone.
